(19) United States
(12) Patent Application Publication
(10) Pub. No.: US 2019/0141206 A1
(43) Pub. Date: May 9, 2019

(54) IMAGE PROCESSING SYSTEM, INFORMATION PROCESSING DEVICE, IMAGE PROCESSING DEVICE AND NON-TRANSITORY RECORDING MEDIUM

(71) Applicant: Konica Minolta, Inc., Tokyo (JP)

(72) Inventors: Atsushi Tomita, Toyohashi-shi (JP); Kazuhiro Tomiyasu, Toyokawa-shi (JP); Tomoko Maruyama, Toyokawa-shi (JP); Kenichi Sawada, Toyohashi-shi (JP); Hiroshi Sugiura, Toyokawa-shi (JP)

(73) Assignee: Konica Minolta, Inc., Tokyo (JP)

(21) Appl. No.: 16/183,817

(22) Filed: Nov. 8, 2018

(30) Foreign Application Priority Data
Nov. 9, 2017 (JP) 2017-216282

(51) Int. Cl. H04N 1/00; G06T 3/60; G06F 3/14

(52) U.S. Cl. CPC H04N 1/00503; H04N 1/00344; H04N 2201/0094; G06T 3/606; G06F 3/1462; H04N 1/00464

(57) ABSTRACT

An image processing system includes: an image processing device that comprises a first display and a first hardware processor; and an information processing device that communicates with the image processing device, and comprises: a second display on which a second screen same as a first screen being displayed on the first display is displayed; and a second hardware processor, wherein one of the first and second hardware processors determines whether a screen display standard of the first display is left or right standard and whether a screen display standard of the second display is left or right standard, and inverts the second screen that is same as the first screen being displayed on the first display and is displayed on the second display right and left, when the screen display standards of the first and second displays are determined to be different from each other.

### CROSS-REFERENCE TO RELATED APPLICATION

Japanese patent application No. 2017-216282 filed on Nov. 9, 2017 including description, claims, drawings, and abstract the entire disclosure is incorporated herein by reference in its entirety.

### BACKGROUND

### Technical Field

The present invention relates to an image processing system, an information processing device, an image processing device and a non-transitory recording medium. The present invention more specifically relates to a technique that enables an operator of the information processing device at remote location to execute an efficient support to a user of the image processing device.

### Description of the Related Art

Conventional image processing systems that enable remote operation devices to remotely control image processing devices such as MFPs (Multifunction Peripherals) over a network are known. This known technique is introduced for example in Japanese Patent Application Laid-Open No. JP 2016-157404 A. According to the known technique, the image processing device sends an operation screen that enables a user to execute an operation to the remote operation device, and receives position information that specifies a position on the operation screen from the remote operation device. In response to receiving the position information, the image processing device determines the operation executed by the user based on the position information, and executes a processing corresponding to the user operation.

Recently, the image processing devices have been placed in every country in the world, and the image processing devices are capable of displaying screens corresponding to a language in each country on operational panels. In order to support users who use the image processing devices, support desks are established in 3 bases, for instance, Europe, United States of America and India. The 24-hour support desks provide a service to support users in each country by using time difference among 3 bases.

An operator of the support desk communicates such as on the phone with the user in each country to give a guidance on an operation procedure of the image processing device, for example. The operator operates an information processing device such as a personal computer (PC) to access the image processing device at remote location and enables the same screen as the screen displayed on the image processing device's operational screen to be displayed on the information processing device. The operator guides the correct operation procedure to the image processing device's user looking at the screen displayed on the information processing device. Moreover, the operator sometimes executes operations to the image processing device for the user based on the screen displayed on the information processing device.

There are two types of the screens displayed on the operational panel of the image processing device. One of them is a left standard screen and another is a right standard screen. If a set language of the image processing device is one of English, Germany and Japanese, for example, a direction of writing letters (directionality of written letters) is from left to right. Thus, the screen displayed on the operational panel would be a left standard screen. On the other hand, if the set language of the image processing device is Arabic or Hebrew, the directionality of written letters is from right to left. Thus, the screen displayed on the operational panel would be a right standard screen.

If each of the left standard screen and the right standard screen is separately designed in a screen designing stage, there will be more waste in design. Normally, the left standard screen is inverted to right and left, and the language is replaced so that the right standard screen is created. For creating the right standard screen by inverting the screen right and left, multiple icon images operable for the user may be included in the left standard screen. In such a case, positions of the multiple icon images are inverted right and left and displayed on the right standard screen.

The operator works for the support desk is acquainted with English, for instance, and is used to guide the operation procedure looking at the left standard screen displayed in English. The user of the image processing device, the set language of which is Arabic, may issue a support request to the operator. The right standard screen corresponding to Arabic is then displayed on the information processing device operated by the operator. The operator cannot understand the language even he or she sees the screen displayed on the information processing device. The operator, therefore, gives guidance on the operation procedure to the user of the image processing device looking at the icon image.

The icon images, however, are arranged in the position different from the one that is familiar with the operator. The operator may confuse, and fail to smoothly give correct guidance as to the operation procedure. The above-described known technique cannot deal with such matters.

### SUMMARY

Thus, one or more embodiments of the present invention provide an image processing system, an information processing device, an image processing device and a non-transitory recording medium capable of enabling an operator to smoothly give correct guidance as to operation procedure even when a screen based on a different standard from a screen which is usually familiar with the operator is displayed on the image processing device.

First, one or more embodiments of the present invention are directed to an image processing system.

The image processing system according to one or more embodiments of the present invention comprises: an image processing device including a first display part and a first hardware processor; and an information processing device capable of communicating with the image processing device and including a second display part on which a screen the same as a screen being displayed on the first display part is enabled to be displayed and a second hardware processor. One of the first hardware processor and the second hardware processor determines whether a screen display standard of the first display part is either left standard or right standard, and determines whether a screen display standard of the second display part is either left standard or right standard, and inverts the screen the same as the screen being displayed on the first display part and is to be displayed on the second display part right and left when the screen display standard of the first display part and the screen display standard of the second display part are determined to be different from each other.

Second, one or more embodiments of the present invention are directed to an information processing device capable of communicating with an image processing device which includes a first display part, and including a second display part which is enabled to display a screen the same as a screen being displayed on the first display part.

The information processing device according to one or more embodiments of the present invention comprises a hardware processor that: determines whether a screen display standard of the first display part is either left standard or right standard, and determines whether a screen display standard of the second display part is either left standard or right standard; and inverts the screen the same as the screen being displayed on the first display part and is to be displayed on the second display part right and left when the screen display standard of the first display part and the screen display standard of the second display part are determined to be different from each other.

Third, one or more embodiments of the present invention are directed to an image processing device.

The image processing device according to one or more embodiments of the present invention comprises: a first display part that displays a screen operable for a user; and a hardware processor that: communicates with an information processing device which includes a second display part capable of displaying a screen the same as the screen being displayed on the first display part; determines whether a screen display standard of the first display part is either left standard or right standard, and determines whether a screen display standard of the second display part is either left standard or right standard; and inverts the screen the same as the screen being displayed on the first display part and is to be displayed on the second display part right and left when the screen display standard of the first display part and the screen display standard of the second display part are determined to be different from each other.

Fourth, one or more embodiments of the present invention are directed to a non-transitory recording medium storing a computer readable program executed by a hardware processor in an information processing device capable of communicating with an image processing device which includes a first display part, and including a second display part which is enabled to display a screen the same as a screen being displayed on the first display part.

The non-transitory recording medium according to one or more embodiments of the present invention stores the computer readable program, execution of the computer readable program by the hardware processor causing the hardware processor in the information processing device to execute: determines whether a screen display standard of the first display part is either left standard or right standard, and determines whether a screen display standard of the second display part is either left standard or right standard; and inverts the screen the same as the screen being displayed on the first display part and is to be displayed on the second display part right and left when the screen display standard of the first display part and the screen display standard of the second display part are determined to be different from each other.

Fifth, one or more embodiments of the present invention are directed to a non-transitory recording medium storing a computer readable program to be executed by a hardware processor in an image processing device that includes a first display part and displays a screen operable for a user on the first display part.

The non-transitory recording medium according to one or more embodiments of the present invention stores the computer readable program, execution of the computer readable program by the hardware processor causing the hardware processor in the image processing device to execute: communicates with an information processing device which includes a second display part capable of displaying a screen the same as the screen being displayed on the first display part; determines whether a screen display standard of the first display part is either left standard or right standard, and determines whether a screen display standard of the second display part is either left standard or right standard; and inverts the screen the same as the screen being displayed on the first display part and is to be displayed on the second display part right and left when the screen display standard of the first display part and the screen display standard of the second display part are determined to be different from each other.

### BRIEF DESCRIPTION OF THE DRAWING

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an exemplary conceptual configuration of an image processing system according to one or more embodiments of the present invention;

FIG. 2 is a flow diagram showing an exemplary operation executed by an image processing device and an information processing device according to one or more embodiments of the present invention;

FIG. 3 illustrates an example of a screen displayed, when a set language of the image processing device is English, according to one or more embodiments of the present invention;

FIG. 4 illustrates an example of a screen displayed, when the set language of the image processing device is Arabic, according to one or more embodiments of the present invention;

FIG. 5 illustrates an example of a screen created by inverting the screen of FIG. 4 right and left;

FIG. 6 illustrates a block diagram showing an example of the hardware structure and the functional structure of the image processing device according to one or more embodiments of the present invention;

FIGS. 7A and 7B each illustrate an example of standard information according to one or more embodiments of the present invention;

FIG. 8 illustrates a block diagram showing an example of the hardware structure and the functional structure of the information processing device according to one or more embodiments of the present invention;

FIG. 9 illustrates an example of display standard determination information according to one or more embodiments of the present invention;

FIG. 10 illustrates a flow diagram explaining an exemplary procedure of processes executed by the information processing device according to one or more embodiments of the present invention;

FIG. 11 illustrates a flow diagram explaining an exemplary procedure of a screen display process of one or more embodiments in detail;

FIG. 12 illustrates a flow diagram explaining an exemplary procedure of an operation information transmission of one or more embodiments in detail;

FIG. 13 illustrates a block diagram showing an example of the hardware structure and the functional structure of the information processing device according to one or more embodiments of the present invention;

FIG. 14 illustrates a flow diagram explaining an exemplary procedure of the operation information transmission executed by the information processing device of one or more embodiments in detail;

FIG. 15 illustrates a flow diagram explaining an exemplary procedure of a screen display process executed by the information processing device of one or more embodiments in detail;

FIG. 16 illustrates a block diagram showing an example of the hardware structure and the functional structure of the information processing device according to one or more embodiments of the present invention;

FIG. 17 illustrates a flow diagram explaining an exemplary procedure of the operation information transmission executed by the information processing device of one or more embodiments in detail;

FIGS. 18A and 18B each illustrate an example of the screen including an image of the image processing device according to one or more embodiments of the present invention;

FIG. 19 illustrates a flow diagram explaining an exemplary procedure of a right/left inversion processing for the screen executed by the information processing device of one or more embodiments;

FIG. 20 illustrates a block diagram showing an example of the hardware structure and the functional structure of the information processing device according to one or more embodiments of the present invention;

FIG. 21 is a flow diagram showing an exemplary operation executed by the image processing device and the information processing device according to one or more embodiments of the present invention;

FIG. 22 illustrates an example of displaying two screens on a display unit according to one or more embodiments of the present invention;

FIG. 23 illustrates a block diagram showing an example of the functional structure of the image processing device according to one or more embodiments of the present invention; and

FIG. 24 is a flow diagram showing an exemplary operation executed by the image processing device and the information processing device according to one or more embodiments of the present invention.

### DETAILED DESCRIPTION OF EMBODIMENTS

Hereinafter, embodiments of the present invention will be described with reference to the drawings. However, the scope of the invention is not limited to the disclosed embodiments.

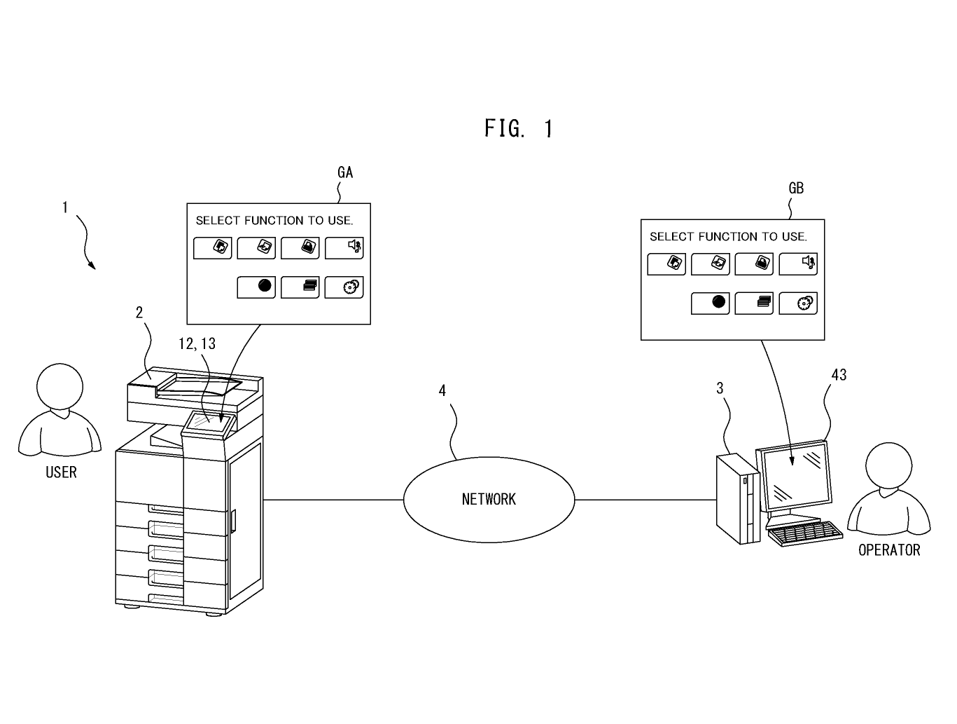

FIG. 1 illustrates an exemplary conceptual configuration of an image processing system 1 according to one or more embodiments of the present invention. The image processing system 1 includes an image processing device 2 and an information processing device 3. The image processing device 2 and the information processing device 3 communicate with each other over a network 4. The network 4 is a wide area network including an internet, for instance. The image processing device 2 is placed in every country in the world, and used by users in each country. The information processing device 3 is placed at a support desk, for example, and used by an operator. Both of the image processing device 2 and the information processing device 3 are placed at remote locations. The country where the image processing device 2 is placed and the country where the information processing device 3 is placed may be different, for example.

The image processing device 2 may be one of MFPs including multiple functions such as a scan function, a print function, a copy function and/or a fax function, for instance. The image processing device 2 may process a job specified by the user. The image processing device 2 is provided with an operational panel 12 to receive inputs from the user. The operational panel 12 includes a display unit 13. A variety of screens on which the user may operate are displayed on the display unit 13. The user executes a variety of operations looking at the screen displayed on the display unit 13, thereby configuring settings as to a job and/or the other settings.

The screen displayed on the display unit 13 of the operational panel 12 corresponds to the set language of the image processing device 2. It is assumed, for example, that the set language of the image processing device 2 is English, Germany or Japanese. In such a case, a screen display standard of the display unit 13 is left standard and a screen based on the left standard is displayed on the display unit 13. This means, the directionality of written English, Germany or Japanese is from left to right, and the screen showing language written from left to right may be referred as left standard screen. On the other hand, it is assumed, for example, that the set language of the image processing device 2 is Arabic or Hebrew. In such a case, a screen display standard of the display unit 13 is right standard. The left standard screen is inverted right and left and the language is replaced to create the right standard screen. The right standard screen thereby created is displayed on the display unit 13. The directionality of written Arabic or Hebrew is from right to left, and the screen showing language written from right to left may be referred as right standard screen.

The information processing device 3 is formed from a personal computer (PC) or a tablet terminal, for example. The information processing device 3 includes a display unit 43 on which a variety of screens are displayed. Normally, the screen displayed on the display unit 43 corresponds to a set language of the information processing device 3. If the set language of the information processing device 3 is English, Germany or Japanese, a screen display standard of the display unit 43 is left standard and a screen based on the left standard is displayed on the display unit 43.

As described above, the user of the image processing device 2 sends a support request to the information processing device 3 placed at the support desk by operating the operational panel 12 when he or she worries about the operation. Once the operator of the information processing device 3 accepts the support request, the screen displayed on the display unit 13 of the operational panel 12 is sent to the information processing device 3 from the image processing device 2. The information processing device 3 displays the screen received from the image processing device 2 on the display unit 43, and enables the operator to figure out the status of the screen which is currently being operated by the user of the image processing device 2. To be more specific, the information processing device 3 may display a screen GB which is the same screen as a screen GA displayed on the operational panel 12 of the image processing device 2 at the remote location.

The screen display standard of the display unit 13 of the image processing device 2 and the screen display standard of the display unit 43 of the information processing device 3 may be different from each other. In such a case, the information processing device 2 inverts the screen received from the image processing device 2 right and left, and displays the right and left inverted screen on the display unit 43. An icon mage included in the screen is arranged at the same position as the position on the screen usually familiar with the operator so that the operator is allowed to smoothly give a guidance on the correct operation without confusion even he or she cannot understand the language included in the screen displayed on the display unit 43. The operator of the information processing device 3 may give the guidance on the correct operation through conversation with the user of the image processing device 2 using a communication method such as a phone.

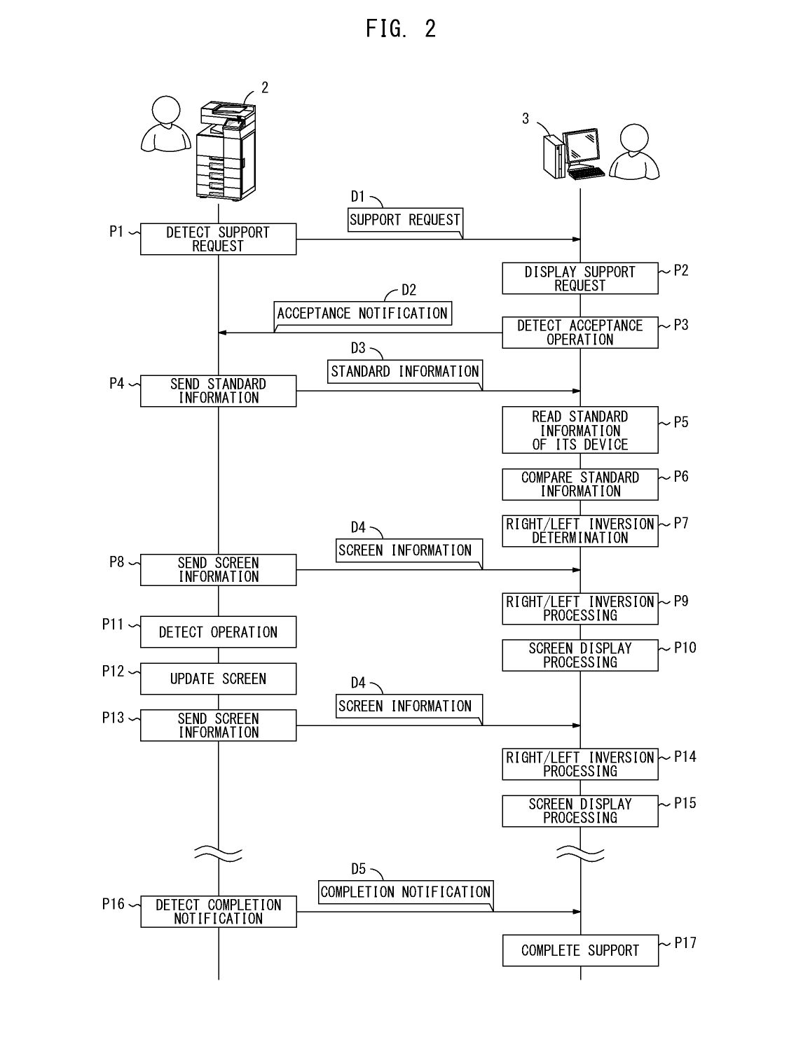

FIG. 2 is a flow diagram showing an exemplary operation executed by the image processing device 2 and the information processing device 3 according to one or more embodiments of the present invention. In response to detecting the support request operation by the user, the image processing device 2 sends a support request D1 to the information processing device 3 (process P1). Upon the receipt of the support request D1, the information processing device 3 informs the receipt of the support request by displaying on the display unit 43 (process P2), and is put into a waiting state to wait for the operation by the operator. In response to detecting the operation to accept by the operator, the information processing device 3 sends an acceptance notification D2 to the image processing device 2 (process P3). A connection between the image processing device 2 and the information processing device 3 is then established to allow interactive communication between the image processing device 2 and the information processing device 3.

After establishing the connection with the information processing device 3, the image processing device 2 sends a standard information D3 (process P4). The standard information D3 shows the screen display standard of the display unit 13 of the operational panel 12. The standard information D3 includes information showing the screen is displayed based on the left standard or the right standard. When the information processing device 3 receives the standard information D3 from the image processing device 2, it reads the standard information of its device (process P5). The information processing device 3 compares the standard information D3 received from the image processing device 2 with its read standard information (process P6), and executes a right/left inversion determination (process P7). More specifically, the information processing device 3 determines if a right/left inversion processing should be executed for the screen received from the image processing device 2. The information processing device 3 stores a result of the right/left inversion determination in a memory, for instance. In a below explanation as to FIG. 2, a case where the information processing device 3 determines the right/left inversion processing should be executed for the screen as the result of the right/left inversion determination is explained.

The image processing device 2 then sends screen information D4 corresponding to the screen currently being displayed on the display unit 13 of the operational panel 12 to the information processing device 3 (process P8). The screen information D4 includes screen data that may be displayed on the display unit 43, for example. The screen data, for instance, is a bitmap image or a web page. Once receiving the screen information D4, the information processing device 3 refers to the result of the right/left inversion determination, and executes the right/left inversion processing for the screen (process P9). The bitmap image may be included in the screen information D4, for instance. In this case, the information processing device 3 extracts the bitmap image in the screen information D4, and inverts each dot position of the bitmap image right and left. The screen information D4 may include a web page. In such a case, the information processing device 3 extracts the web page in the screen information D4, and inverts each display position of each content included in the web page right and left. As described above, the screen displayed on the display unit 13 of the image processing device 2 is inverted right and left, and the right and left inverted screen is created. The information processing device 3 displays the right and left inverted screen on the display unit 43 (process P10).

The same process is executed when the image processing device 2 updates the screen. To be more specific, after detecting the user operation (process P11), the image processing device 2 updates the screen displayed on the display unit 13 (process P12). Together with that, the image processing device 2 sends the screen information D4 corresponding to the updated screen to the information processing device 3 (process P13). The information processing device 3 then executes the right/left inversion processing for the screen (process P14), and displays the right and left inverted screen on the display unit 43 (process P15).

When completing the support by the operator, the user of the image processing device 2 executes a completion request operation to the operational panel 12. Once detecting the completion request operation, the image processing device 2 sends a completion notification D5 to the information processing device 3 (process P16). The information processing device 3 then completes the support processing based on the completion notification D5 (process P17). Thus, the connection between the image processing device 2 and the information processing device 3 is cancelled.

During the above-described process executed by the image processing device 2 and the information processing device 3, the operator may operate the screen displayed on the display unit 43 for the user so that the operator may give the correct guidance on the operation to the user. In such a case, the information processing device 3 generates coordinate information that indicates the position operated by the operator in the screen displayed on the display unit 43, and sends operation information including the coordinate information to the image processing device 2. The screen displayed on the display unit 43 may be the right and left inverted screen which is created through the right/left inversion processing for the screen displayed on the image processing device 2. In such a case, the information processing device 3 executes a processing to invert the coordinate information right and left. The information processing device 3 then sends the operation information including the right and left inverted coordinate information. Thus, the image processing device 2 may accurately identify the position operated by the operator. Also, the image processing device 2 may appropriately update the screen displayed on the display unit 13 in response to the remote operation by the operator.

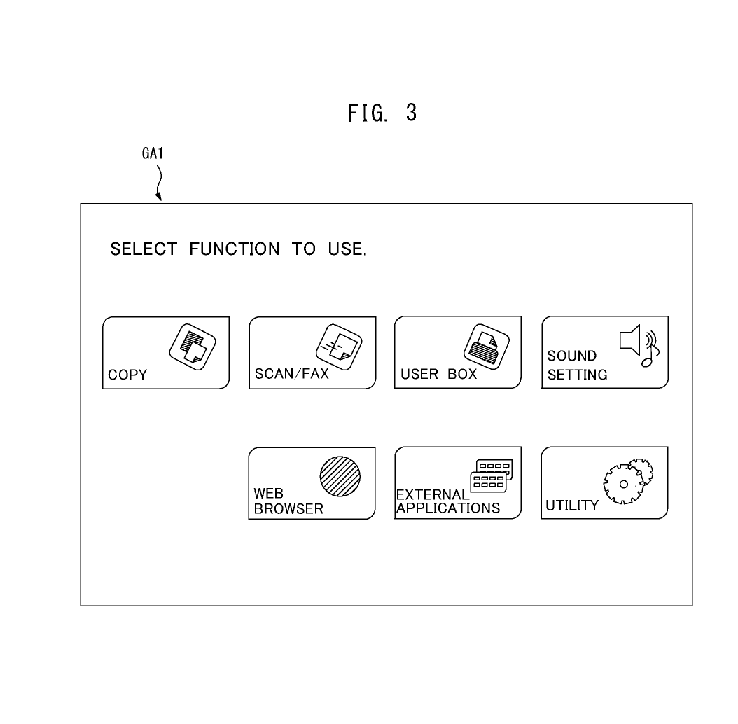

FIG. 3 illustrates an example of a screen displayed on the display unit 13, when the set language of the image processing device 2 is English, according to one or more embodiments of the present invention. When the set language is English, the screen display standard will be left standard. In the example of FIG. 3, seven icon images operable for the user are arranged in the screen. It is assumed, for example that the set language of the image processing device 2 is English and the set language of the information processing device 3 is also English. In such a case, the screen display standards of both devices are the same. When the information processing device 3 obtains the screen GA1 of FIG. 3 from the image processing device 2 and displays it, the right/left inversion processing is unnecessary. The screen fully same as the screen GA1 of FIG. 3 is displayed on the display unit 43 of the information processing device 3.

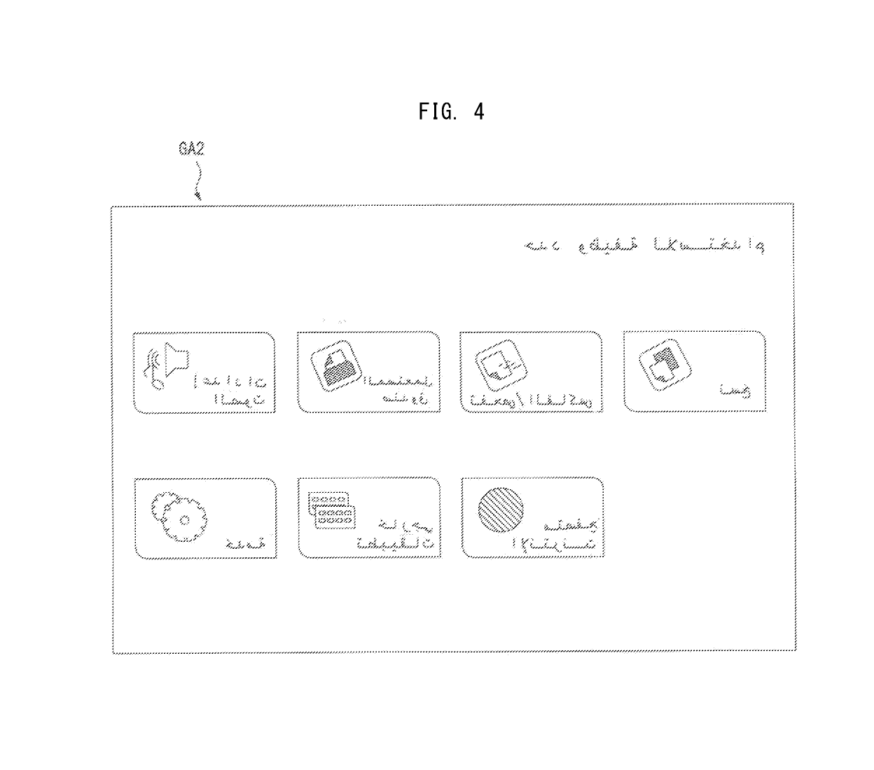

FIG. 4 illustrates an example of a screen displayed on the display unit 13, when the set language of the image processing device 2 is Arabic, according to one or more embodiments of the present invention. When the set language is Arabic, the screen display standard will be right standard. A screen GA2 of FIG. 4 is created by inverting the screen GA1 of FIG. 3 right and left and replacing the language to Arabic. The positions of the seven icon images on the screen GA2 may be different from those on the screen GA1. It is assumed, for example, that the set language of the image processing device 2 is English and the set language of the information processing device 3 is Arabic. In such a case, the screen display standard of the devices are different from each other. When the information processing device 3 obtains the screen GA2 of FIG. 4 from the image processing device 2 and displays it, the right/left inversion processing is executed.

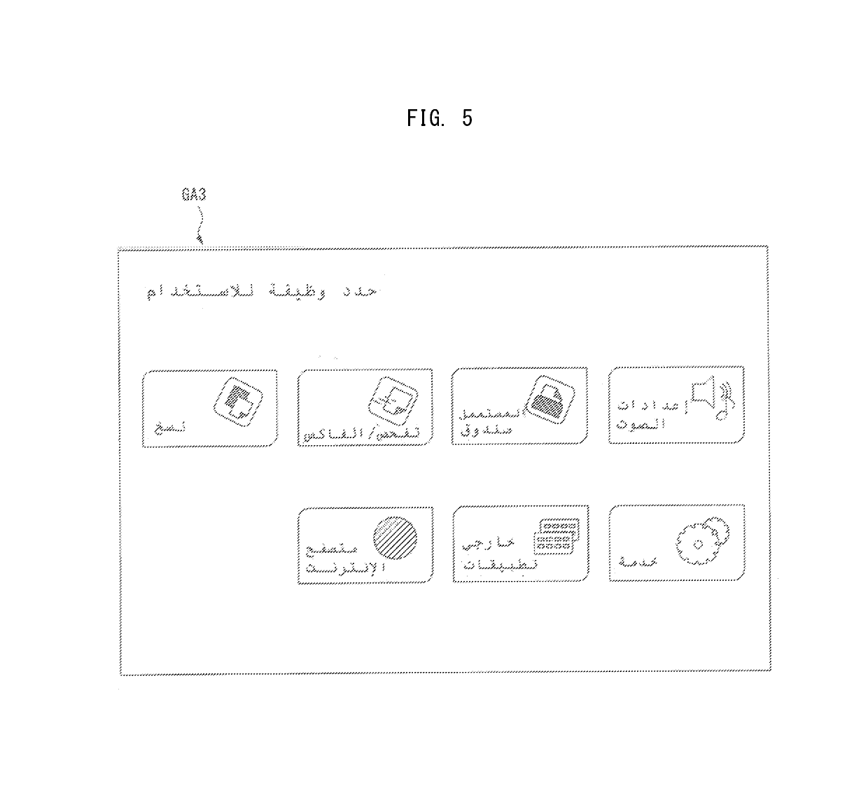

FIG. 5 illustrates an example of the screen created by inverting the screen GA2 of FIG. 4 right and left. As illustrated in FIG. 5, a screen GA3 is created by inverting the screen GA2 right and left. The seven icon images on the screen GA3 are displayed in the same positions as those on the screen GA1 of FIG. 3. Even the operator cannot understand the language displayed on the screen GA3, the multiple icon images are displayed in the positions familiar with him or her so that he or she may give the smooth guidance on the correct operation.

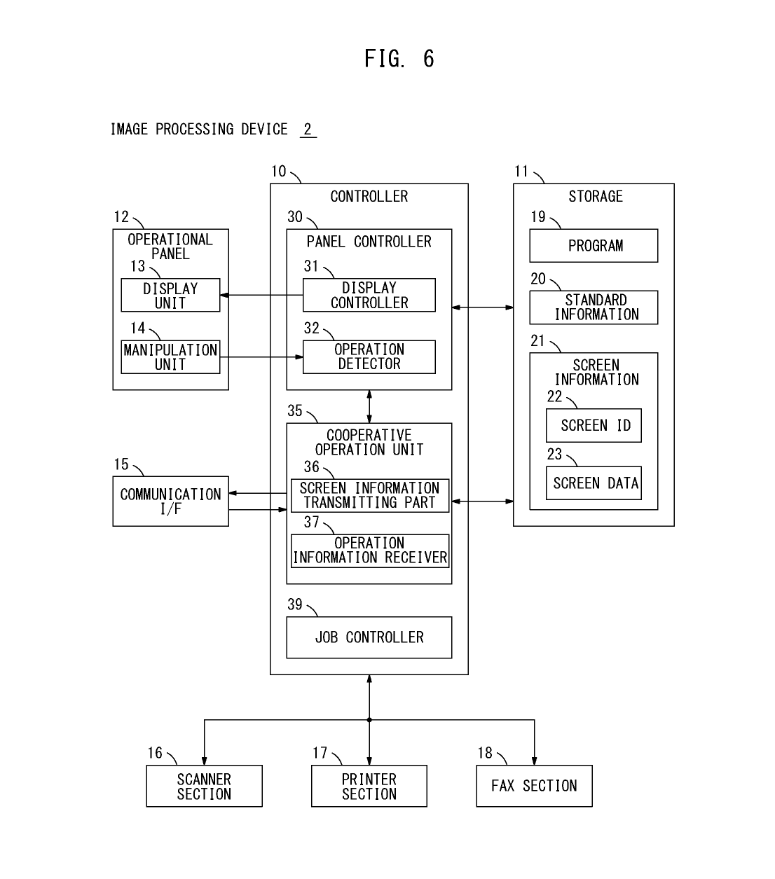

A hardware structure and a functional structure of the image processing device 2 are explained next. FIG. 6 illustrates a block diagram showing an example of the hardware structure and the functional structure of the image processing device 2 according to one or more embodiments of the present invention. As its hardware structure, the image processing device 2 includes a controller 10, a storage 11, the operational panel 12, a communication interface 15, a scanner section 16, a printer section 17 and a fax section 18.

The controller 10 may include a CPU and a memory which are not shown in FIG. 6. The controller 10 controls operations of each part. The CPU reads and executes a program 19 stored in the storage 11 so that the controller 10 serves as a panel controller 30, a cooperative operation unit 35 and a job controller 39.

The storage 11 is formed from a non-volatility device such as a hard disk drive (HDD), for example, and is one kind of a computer readable recording medium. The program 19, standard information 20 and screen information 21 are stored in the storage 11.

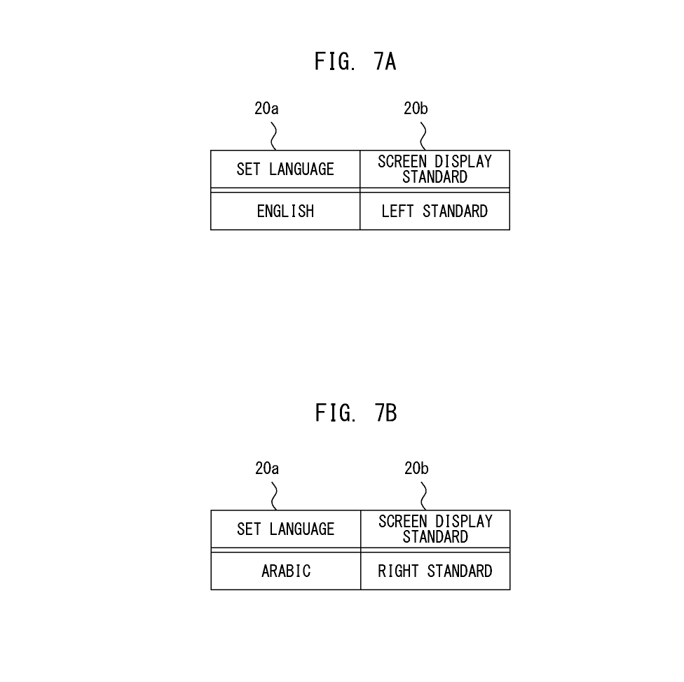

FIGS. 7A and 7B each illustrate an example of the standard information 20 according to one or more embodiments of the present invention. The standard information 20, for example, includes information 20a as to the set language and information 20b as to the screen display standard. The detail of the standard information 20 differs depending on the set language of the image processing device 2. If the set language of the image processing device 2 is English, for instance, the standard information 20 includes information showing English and left standard as illustrated in FIG. 7A. On the other hand, if the set language of the image processing device 2 is Arabic, for instance, the standard information 20 includes information showing Arabic and right standard as illustrated in FIG. 7B.

Referring back to FIG. 6, the screen information 21 includes a screen ID 22 and screen data 23. The screen ID 22 is unique screen identification information assigned to each screen. The screen ID 22 enables to identify a single screen from among many screens. The screen data 23 may be displayed on the display unit 13 and the display unit 43. The screen data 23 has data formats such as a bit map image and/or a web page as described above, for example. The many pieces of screen information 21 corresponding to the respective multiple screens are stored in the storage 11.

The operational panel 12 is a user interface for the user to use the image processing device 2. The operational panel 12 includes the display unit 13 as described above and a manipulation unit 14 which receives user operations. The display unit 13 is constructed by a device such as a color liquid crystal display, for instance. A variety of screens operable for the user may be displayed on the display unit 13. The manipulation unit 14 is constructed by parts such as a touch panel sensor arranged on the display area of the display unit 13 and/or push-button keys arranged around the display area of the display unit 13.

The communication interface 15 connects the image processing device 2 to the network 4. The image processing device 2 communicates with the information processing device 3 via the communication interface 15.

The scanner section 16 becomes operative when the scan function or the copy function is selected to optically read a document placed by the user and construct image data. The printer section 17 becomes operative when the print function or the copy function is selected to form images on a sheet material such as a printing paper and produce a printed output based on the input image data. The fax section 18 transmits and receives fax data over public phone lines, which are not shown in FIG. 6.

The panel controller 30 controls the operational panel 12. The panel controller 30 includes a display controller 31 and an operation detector 32. The display controller 31 reads the screen information 21 in the storage 11 and extracts the screen data 23. The display controller 31 outputs the image based on the screen data 23 to the display unit 13, thereby enabling the display unit 13 to display the screen operable for the user. The display controller 31 also includes a web browser function. When the screen data 23 is a web page, the display controller 31 enables the screen based on the web page to be displayed on the display unit 13 with the web browser function. The operation detector 32 detects the user operation when the user operation is received by the manipulation unit 14.

It is assumed, for example the user touches the screen displayed on the display unit 13. In such a case, the operation detector 32 generates the coordinate information indicating the position touched by the user. The operation detector 32 then designates the operation executed by the user based on the coordinate information. If the user operation is to update the screen of the display unit 13, the operation detector 32 instructs the display controller 31 to update the screen. The display controller 31 then updates the screen displayed on the display unit 13 based on the user operation.

If the operation executed by the user is the support request operation, the operation detector 32 brings the cooperative operation unit 35 of the controller 10 into operation.

The cooperative operation unit 35 executes operations in cooperation with the information processing device 3. The cooperative operation unit 35 is brought into operation once the support request operation executed by the user is detected, and completes its operation as the completion request operation by the user is detected. The cooperative operation unit 35 includes a screen information transmitting part 36 and an operation information receiver 37. Once the support request operation by the user is detected, for example, the cooperative operation unit 35 sends the support request D1 to the information processing device 3. In response to receiving the acceptance notification D2 from the information processing device 3, the cooperative operation unit 35 brings the screen information transmitting part 36 and the operation information receiver 37 into operation. When detecting the completion request operation by the user, the cooperative operation unit 35 sends the completion notification D5 to the information processing device 3, and completes the cooperative operation with the information processing device 3.

The screen information transmitting part 36 reads the standard information 20 in the storage 11 at the start of the cooperative operation with the information processing device 3, and sends the read standard information 20 to the information processing device 3 as the standard information D3 as illustrated in FIG. 2. As a result, the information processing device 3 may obtain the standard information 20 from the image processing device 2 at the start of the cooperative operation with the image processing device 2.

The screen information transmitting part 36 also sends the screen information 21 corresponding to the screen displayed on the display unit 13 to the information processing device 3 as the screen information D4 as illustrated in FIG. 2. To be more specific, the screen information transmitting part 36 communicates with the panel controller 30, and obtains the screen information 21 corresponding to the screen currently displayed on the display unit 13 by the display controller 31. The screen information transmitting part 36 may obtain the screen information 21 from the panel controller 30. Alternatively, the screen information transmitting part 36 may read and obtain the screen information 21 in the storage 11. The screen information transmitting part 36 sends the obtained screen information 21 to the information processing device 3. The information processing device 3 then may obtain the screen information 21 corresponding to the screen currently displayed on the display unit 13 of the operational panel 12.

The operation information receiver 37 outputs the operation information to the panel controller 30 in response to receiving the operation information from the information processing device 3. The operation information is processed by the operation detector 32 of the panel controller 30. More specifically, the operation detector 32 analyzes the operation information received from the information processing device 3 and designates the operation executed by the operator. The operation detector 32 then executes the process based on the operation executed by the operator. The operation executed by the operator may be the operation to update the screen of the display unit 13, for instance. In such a case, the operation detector 32 instructs the display controller 31 to update the screen. The screen displayed on the display unit 13 of the operational panel 12 is then updated in response to the remote operation by the operator.

Once the screen displayed on the display unit 13 is updated, the screen information transmitting part 36 becomes operative once again to execute the above-identified process. Every time the screen displayed on the display unit 13 is updated, the screen information 21 corresponding to the screen currently being displayed is sent to the information processing device 3 from the image processing device 2.

The job controller 30 activates at least one of the scanner section 16, the printer section 17 and the fax section 18 so that it controls execution of the job specified by the user. While the cooperative operation unit 35 is in operation, the job controller 39 may control execution of the job specified by the operator.

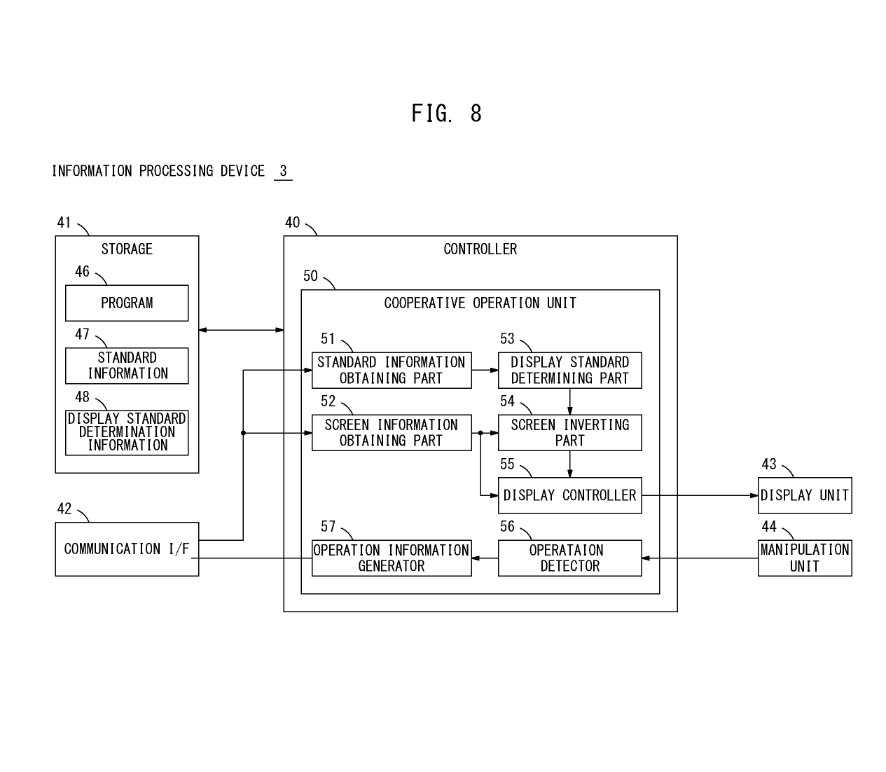

A hardware structure and a functional structure of the information processing device 3 are explained next. FIG. 8 illustrates a block diagram showing an example of the hardware structure and the functional structure of the information processing device 3 according to one or more embodiments of the present invention. As its hardware structure, the information processing device 3 includes a controller 40, a storage 41, a communication interface 42, the display unit 43 and a manipulation unit 44.

The controller 40 may include a CPU and a memory which are not shown in FIG. 8. The controller 40 controls operations of each part. The CPU reads and executes a program 46 stored in the storage 41 so that the controller 40 serves as a cooperative operation unit 50. The CPU may execute the program 46 at any timing. The CPU may automatically read and execute the program 46 when the information processing device 3 is powered on, for example, and may bring the cooperative operation unit 50 into operation. The CPU may read and execute the program 46 when an execution instruction of the program 46 given by the operator is detected, for example, and may bring the cooperative operation unit 50 into operation.

The storage 41 is formed from a non-volatility device such as a hard disk drive (HDD) or a solid state drive (SSD), for example, and is one kind of a computer readable recording medium. The program 46, standard information 47 and display standard determination information 48 are stored in the storage 41.

The standard information 47 indicates the screen display standard for displaying the screen on the display unit 43 of the information processing device 3. The standard information 47 has the similar data structure as the standard information 20 of FIGS. 7A and 7b, for example. The standard information 47, therefore, differs depending on the set language of the information processing device 3. If the set language of the information processing device 3 is English, for instance, the standard information 47 includes information indicating English and left standard.

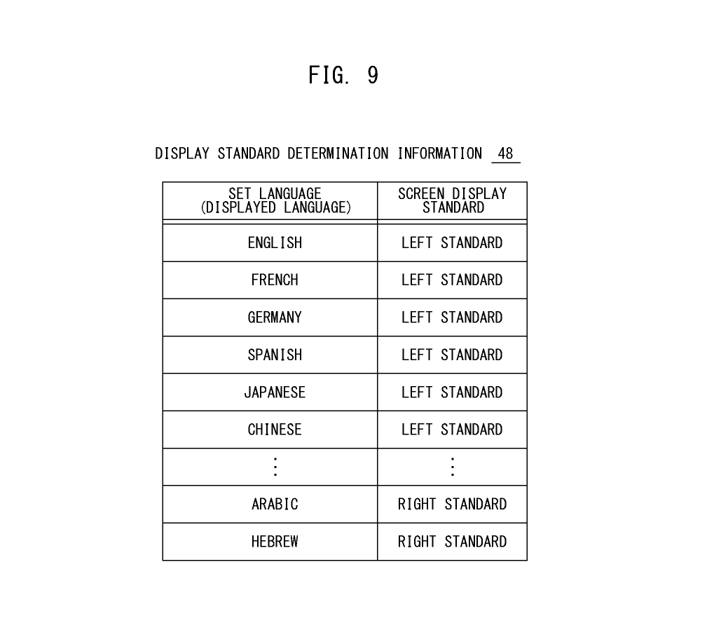

The display standard determination information 48 is to be referred in comparison of the screen display standard of the image processing device 2 and the screen display standard of the information processing device 3 with each other. FIG. 9 illustrates an example of the display standard determination information 48 according to one or more embodiments of the present invention. As illustrated in FIG. 9, multiple languages are registered with the display standard determination information 48. The display standard determination information 48 includes the multiple languages and the screen display standard corresponding to each of the multiple languages. The standard information 20 and 47 may only include the information relating to the set language, for example. Even in such a case, the screen display standard corresponding to the set language may be identified with reference to the display standard determination information 48.

Referring back to FIG. 8, the communication interface 42 connects the information processing device 3 to the network 4. The information processing device 3 communicates with the image processing device 2 via the communication interface 42.

The display unit 43 is constructed by a device such as a color liquid crystal display, for instance. A variety of screens operable for the operator may be displayed on the display unit 43. When, for example, the information processing device 3 receives the screen information 21 from the image processing device 2, the display unit 43 may display the screen based on the screen data 23 included in the received screen information 21.

The manipulation unit 44 is a device that enables the operator to execute input operations, and constructed by parts such as a keyboard and/or a mouse. The manipulation unit 44 may include touch panel keys arranged on the display area of the display unit 43.

After the cooperative operation unit 50 becomes operative in the controller 40, it is put into a waiting state until receiving the support request D1 from the image processing device 2. In response to receiving the support request D1 from the image processing device 2, the cooperative operation unit 50 informs that the support request is received by displaying on the display unit 43 and waits until the operation is executed by the operator. When detecting the acceptance operation by the operator, the cooperative operation unit 50 sends the acceptance notification D2 to the image processing device 2.

As illustrated in FIG. 8, the cooperative operation unit 50 includes a standard information obtaining part 51, a screen information obtaining part 52, a display standard determining part 53, a screen inverting part 54, a display controller 55, an operation detector 56 and an operation information generator 57. In response to sending the acceptance notification D2 to the image processing device 2, the cooperative operation unit 50 brings each part into operation.

When the communication interface 42 receives information from the image processing device 2, the standard information obtaining part 51 determines if the received information is the standard information 20. If the received information is the standard information 20, the standard information obtaining part 51 obtains the standard information 20. The standard information obtaining part 51 outputs the standard information 20 obtained from the image processing device 2 to the display standard determining part 53.

When the communication interface 42 receives information from the image processing device 2, the screen information obtaining part 52 determines if the received information is the screen information 21. If the received information is the screen information 21, the screen information obtaining part 52 obtains the screen information 21. The screen information obtaining part 52 extracts the screen data 23 from the obtained screen information 21, and outputs the screen data 23 to the screen inverting part 54 or the display controller 55.

After obtaining the standard information 20 of the image processing device 2, the display standard determining part 53 determines whether the screen display standard of the display unit 13 of the image processing device 2 is the left standard or the right standard. The display standard determining part 53 may refer to the display standard determination information 48. The display standard determining part 53 reads the standard information 47 in the storage 41, and determines whether the screen display standard of the display unit 43 of its device is the left standard or the right standard. The display standard determining part 53 compares the screen display standard of the display unit 13 and the screen display standard of the display unit 43 with each other, thereby determining whether or not both standards are the same.

The screen display standard of the display unit 13 and the screen display standard of the display unit 43 may be the same. In such a case, the information processing device 3 determines the right/left inversion processing for the screen for displaying the screen obtained from the image processing device 2 on the display unit 43 is unnecessary. On the other hand, the screen display standard of the display unit 13 and the screen display standard of the display unit 43 may be differ from each other. In such a case, the information processing device 3 determines the right/left inversion processing for the screen for displaying the screen obtained from the image processing device 2 on the display unit 43 is necessary. The display standard determining part 53 temporarily stores the result of the determination which is obtained by comparing the screen display standard of the display unit 13 and the screen display standard of the display unit 43 with each other in the memory of the controller 40, for instance. The determination result stored in the memory, for instance, is deleted at the timing when the cooperative operation between the image processing device 2 and the information processing device 3 is complete.

In response to obtaining the screen information 21 from the image processing device 2, the screen information obtaining part 52 refers to the determination result conducted by the display standard determining part 53 stored in the memory. When the right/left inversion processing for the screen is not necessary for displaying the screen obtained from the image processing device 2 on the display unit 43, the screen information obtaining part 52 outputs the screen data 23 extracted from the screen information 21 to the display controller 55. On the other hand, if the right/left inversion processing for the screen is necessary for displaying the screen obtained from the image processing device 2 on the display unit 43, the screen information obtaining part 52 outputs the screen data 23 extracted from the screen information 21 to the screen inverting part 54.

The screen inverting part 54 executes the processing to invert the screen obtained from the image processing device 2 right and left when it is determined the screen display standard of the display unit 13 and the screen display standard of the display unit 43 are different from each other. To be more specific, the screen inverting part 54 extracts the screen data 23 from the screen information 21 received from the screen information obtaining part 52, and executes the right/left inversion processing for the screen data 23. Thus, the screen obtained from the image processing device 2 is converted into the right and left inverted screen. The screen inverting part 54 outputs the right and left inverted screen data 23 to the display controller 55.

The display controller 55 outputs the image based on the screen data 23 received from the screen information obtaining part 52 or the screen inverting part 54 to the display unit 43 so that the screen operable for the operator may be displayed on the display unit 43. The display controller 55 also includes a web browser function. When the screen data 23 is a web page, the display controller 55 enables the screen based on the web page to be displayed on the display unit 43 with the web browser function.

If the screen display standard of the display unit 13 and the screen display standard of the display unit 43 are completely matched with each other, the same screen as the screen displayed on the display unit 13 of the image processing device 2 may be displayed on the display unit 43 of the information processing device 3. In such a case, the operator looks at the same screen as the screen looked by the user of the image processing device 2 in the same status. If the screen display standard of the display unit 13 and the screen display standard of the display unit 43 are different from each other, the screen created by inverting the screen displayed on the display unit 13 of the image processing device 2 right and left is displayed on the display unit 43 of the information processing device 3. The operator looks at the screen created by inverting the same as the screen looked by the user of the image processing device 2 right and left.

The operation detector 56 detects the operation executed by the operator to the manipulation unit 44. In response to detect the operator's operation, the operation detector 56 outputs an operation detecting signal to the operation information generator 57.

The operation information generator 57 identifies the detail of the operation executed by the operator and generates the operation information showing the detail of the operation based on the operation detecting signal received from the operation detector 56. The operator may operates a specific position on the screen displayed on the display unit 43 by operating the device such as the mouse, for example. In such a case, the operation information generator 57 generates the coordinate information showing the operated position by the operator on the screen, and generates the operation information including the coordinate information.

In generating the coordinate information, the operation information generator 57 determines whether or not the screen displayed on the display unit 43 is the right and left inverted screen. If the screen displayed on the display unit 43 is not the right and left inverted screen, the operation information generator 57 generates the coordinate information based on the screen display standard in accordance with the standard information 47. The screen display standard in accordance with the standard information 47 may be left standard, for instance. In such case, the operation information generator 57 generates the coordinate information with the origin located at the top left corner or lower left corner of the screen.

If the screen displayed on the display unit 43 is the right and left inverted screen, the operation information generator 57 generates the coordinate information in the similar manner as described above, and inverts the coordinate information right and left. The operation information generator 57 generates the operation information including the right and left inverted coordinate information. However, this is given not for limitation. If the screen displayed on the display unit 43 is the right and left inverted screen, the operation information generator 57 may generate the coordinate information based on the different standard from the screen display standard in accordance with the standard information 47 to generate the right and left inverted coordinate information. When the display screen standard in accordance with the standard information 47 is the left standard, the operation information generator 57 may generate the coordinate information with the origin located at the top right corner or lower right corner of the screen to generate the right and left inverted coordinate information.

The operation information generator 57 sends the operation information generated as described above to the image processing device 2. The image processing device 2 is then enabled to identify the operation executed by the operator based on the operation information received from the information processing device 3 and executes the process in response to the operation. The screen received from image processing device 2 may be inverted right and left and the right and left inverted screen may be displayed on the information processing device 3. Especially even in such a case, the coordinate information received from the information processing device 3 is the information generated based on the screen display standard of the screen displayed on the image processing device 2 so that the operation executed by the operator may be accurately identified.

In one or more embodiments, when the screen display standard of the image processing device 2 and the screen display standard of the information processing device 3 are different from each other, the screen obtained by the information processing device 3 from the image processing device 2 is inverted right and left and displayed. When the operator executes the operation to the screen of the display unit 43, the information processing device 3 inverts the coordinate information right and left and sends the right and left inverted coordinate information to the image processing device 2. The image processing device 2 only has to execute the same processing every time despite the screen is inverted right and left by the information processing device 3.

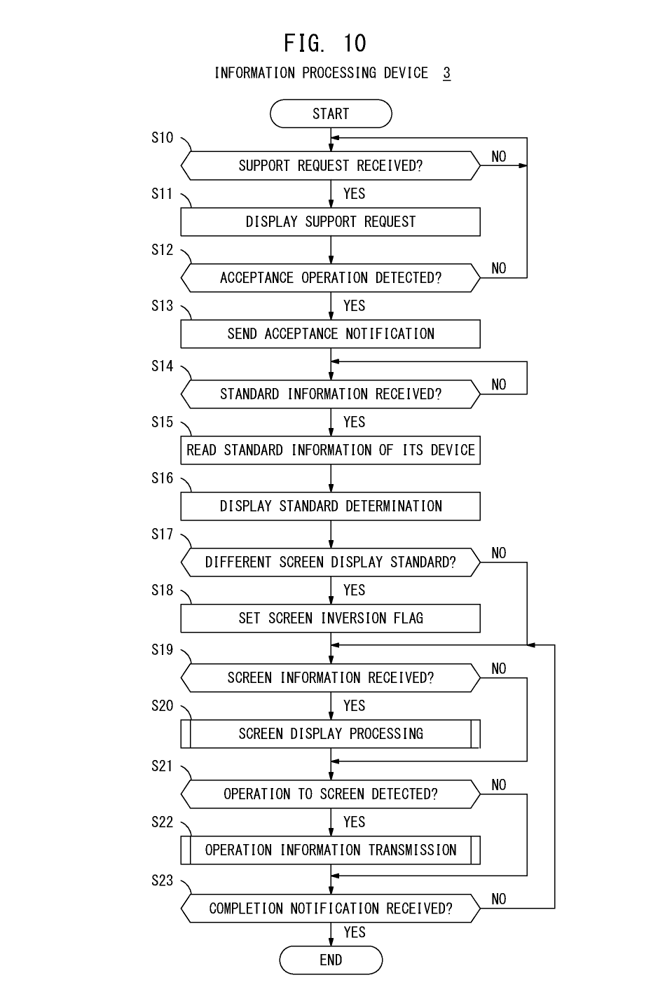

A process sequence executed by the information processing device 3 is explained next. FIGS. 10 to 12 illustrate flow diagrams explaining an exemplary procedure of processes executed by the information processing device 3 according to one or more embodiments of the present invention. This process is executed when the program 46 is executed by the information processing device 3, and is executed by the above-described cooperative operation unit 50. Upon the start of the process, the information processing device 3 waits until receiving the support request D1 from the image processing device 2 (step S10). In response to receiving the support request D1 from the image processing device 2 (when a result of step S10 is YES), the information processing device 3 informs that the support request is received from the image processing device 2 by displaying it (step S11). The information processing device 3 determines if the acceptance operation by the operator is detected (step S12). The acceptance operation by the operator may not be detected in a predetermined period of time or the operator may execute the operation to refuse acceptance, for instance (when a result of step S12 is NO). In this case, the process executed by the information processing device 3 returns to the process in step S10. The acceptance operation by the operator may be detected (when a result of step S12 is YES). In this case, the information processing device 3 sends the acceptance notification D2 to the image processing device 2 (step S13). From step S14, the process for the operator to support the user is started by the information processing device 3.

Once entering the process to support the user of the image processing device 2, the information processing device 3 waits until receiving the standard information 20 from the image processing device 2 (step S14). After receiving the standard information 20 from the image processing device 2 (when a result of step S14 is YES), the information processing device 3 reads the standard information 47 stored therein (step S15), and executes a display standard determination (step S16). To be more specific, the information processing device 3 brings the display standard determining part 53 of the cooperative operation unit 50 into operation to compare the screen display standard of the image processing device 2 and the screen display standard of the information processing device 3 with each other so that whether both of them have the same standards or each of them has a different standard may be determined.

The information processing device 3 refers to the result of the display standard determination. When the screen display standard of the image processing device 2 and the screen display standard of the information processing device 3 are different from each other (when a result of step S17 is YES), the information processing device 3 sets a screen inversion flag (step S18). The screen inversion flag is set in a predetermined storage region such as the memory of the controller 40 as the result of the determination by the display standard determining part 53. On the other hand, when the screen display standard of the image processing device 2 and the screen display standard of the information processing device 3 are the same (when a result of step S17 is NO), the information processing device 3 does not set the screen inversion flag.

The information processing device 3 determines if the screen information 21 is received from the image processing device 2 (step S19). In response to receiving the screen information 21 (when a result of step S19 is YES), the information processing device 3 executes a screen display process (step S20). The screen information 21 may not be received (when a result of step S19 is NO). In this case, the information processing device 3 does not execute the screen display process.

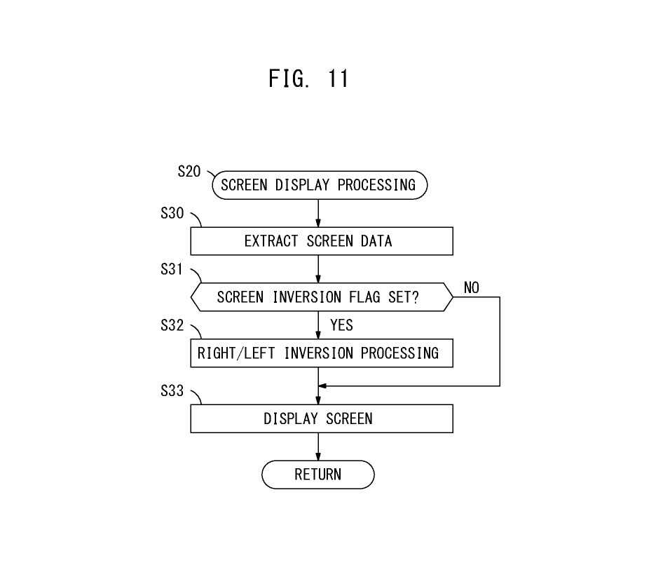

FIG. 11 illustrates a flow diagram explaining an exemplary procedure of the screen display process (step S20) in detail. After receiving the screen information 21, the information processing device 3 extracts the screen data 23 from the screen information 21 (step S30). The information processing device 3 determines if the screen inversion flag is set (step S31). The screen inversion flag may be set (when a result of step S31 is YES). In such a case, the information processing device 3 executes the right/left inversion processing with the screen data 23 extracted in step S30 (step S32). The screen inversion flag may not be set (when a result of step S31 is NO). In such a case, the information processing device 3 does not execute the right/left inversion processing. The information processing device 3 then displays the screen on the display unit 43 based on the screen data 23 (step S33). Hence, if the screen inversion flag is set, the right and left inverted screen is displayed on the display unit 43. If the screen inversion is not set, the screen obtained from the image processing device 2 is displayed as it is.

Referring back to FIG. 10, the information processing device 3 determines whether or not the operation executed by the operator to the screen displayed on the display unit 43 is detected (step S21). In response to detecting the operator's operation (when a result of step S21 is YES), the information processing device 3 executes an operation information transmission (step S22). The operator's operation may not be detected (when a result of step S21 is NO). In this case, the information processing device 3 does not execute the operation information transmission.

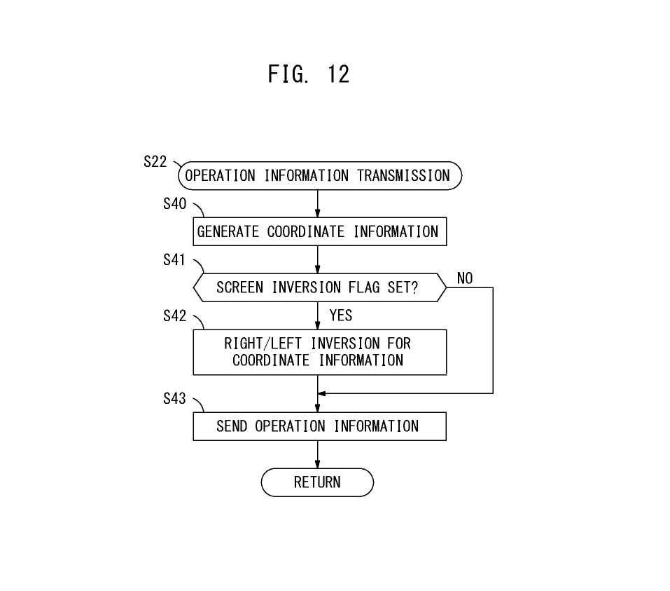

FIG. 12 illustrates a flow diagram explaining an exemplary procedure of the operation information transmission (step S22) in detail. In response to detecting the operator's operation, the information processing device 3 generates the coordinate information (step S40). The information processing device 3 generates the coordinate information based on the screen display standard in accordance with the standard information 47 stored therein regardless whether the right and left inverted screen is displayed on the display unit 43. The information processing device 3 determines whether or not the screen inversion flag is set (step S41). When the screen inversion flag is set (when a result of step S41 is YES), the information processing device 3 executes the right and left inversion processing for the coordinate information (step S42). When the screen inversion flag is not set (when a result of step S41 is NO), the information processing device 3 does not execute the right and left inversion processing for the coordinate information. The information processing device 3 then generates the operation information including the coordinate information and sends the generated operation information to the image processing device 2 (step S43). Hence, if the screen inversion flag is set, the coordinate information showing the position on the screen operated by the operator is inverted right and left and the right and left inverted coordinate information is sent to the image processing device 2. If the screen inversion flag is not set, the coordinate information showing the position on the screen operated by the operator is sent to the image processing device 2 as it is.

Referring back again to FIG. 10, the information processing device 3 determines if the completion notification D5 is received from the image processing device 2 (step S23). When the completion notification D5 is received (when a result of step S23 is NO), the information processing device 3 completes the process. When the completion notification D5 is not received, the information processing device 3 returns to the process in step S19 and repeats the above-described process. When, therefore, the screen displayed on the image processing device 2 is updated and the new screen is obtained from the image processing device 2, the information processing device 3 repeatedly executes the process to display the screen on the display unit 43.

As described above, the image processing system 1 of one or more embodiments includes the display standard determining part 53 and the screen inverting part 54. The display standard determining part 53 determines whether the screen display standard of the display unit 13 of the image processing device 2 is the left standard or the right standard, and also determines the screen display standard of the display unit 43 of the information processing device 3 is the left standard or the right standard. When the display standard determining part 53 determines that the screen display standard of the display unit 13 and the screen display standard of the display unit 43 are different from each other, the screen inverting part 54 inverts the screen right and left for displaying the screen the same as the screen displayed on the display unit 13 on the display unit 43.

The operator may not understand the language included in the screen obtained from the image processing device 2. Even in such a case, the icon image included in the screen may be displayed in the position familiar with the operator. As a result, the operator is allowed to smoothly give a correct guidance on the operation procedure to the user of the image processing device 2.

As described above, even when the screen displayed on the image processing device is the screen based on the standard different from the standard based on which the screen familiar with the operator is displayed, the operator is enabled to give a smooth guidance on the correct operation procedure.

Additional embodiments of the present invention are explained next. In the above-described embodiments, when the screen display standard of the image processing device 2 and the screen display standard of the information processing device 3 are different from each other, the right/left inversion processing for the screen is executed at the timing when the information processing device 3 obtains the screen from the image processing device 2. Then it makes more difficult for the operator who is acquainted with Arabic or Hebrew if the screen is inverted right and left. In one or more embodiments, even when the screen display standard of the image processing device 2 and the screen display standard of the information processing device 3 are different from each other, the information processing device 3 displays the screen obtained from the image processing device 2 as it is. If the operator takes long to execute operation to the screen, the information processing device 3 inverts the screen right and left.

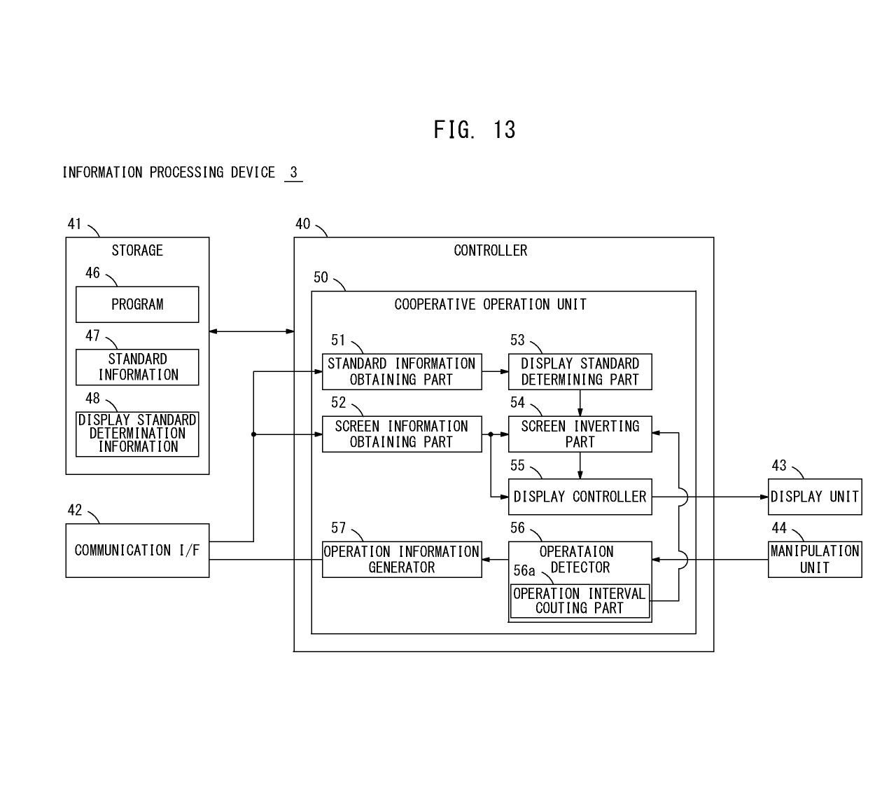

FIG. 13 illustrates a block diagram showing an example of the hardware structure and the functional structure of the information processing device 3 according to one or more embodiments of the present invention. The operation detector 56 is the only difference between the information processing device 3 of one or more embodiments shown in FIG. 13 and the information processing device 3 of the above-described embodiments. The operation detector 56 of one or more embodiments includes an operation interval counting part 56a.

Upon the start of the cooperative operation with the image processing device 2 by the cooperative operation unit 50, the display standard determining part 53 determines if the screen display standard of the image processing device 2 and the screen display standard of the information processing device 3 are the same, and temporarily stores the determination result in the storage region such as the memory. Even when the image inversion flag is set in the storage region such as the memory by the display standard determining part 53, the information processing device 3 of one or more embodiments does not immediately enables the screen inverting part 54 to execute the screen inversion processing and displays the screen obtained from the image processing device 2 on the display unit 43 as it is. If a screen inversion instruction is output by the operation interval counting part 56a, the information processing device 3 brings the screen inverting part 54 into operation and changes to display the right and left inverted screen on the display unit 43 since then.

The operation interval counting part 56a becomes operative when the display standard determining part 53 determines that the screen display standard of the image processing device 2 and the screen display standard of the information processing device 3 are different. The operation interval counting part 56a counts a time interval of the operations by the operator while the screen obtained from the image processing device 2 is displayed on the display unit 43 as it is. In response to detecting that the counted time interval of the operations by the operator is longer than a predetermined period of time, the operation interval counting part 56a outputs the screen inversion instruction.

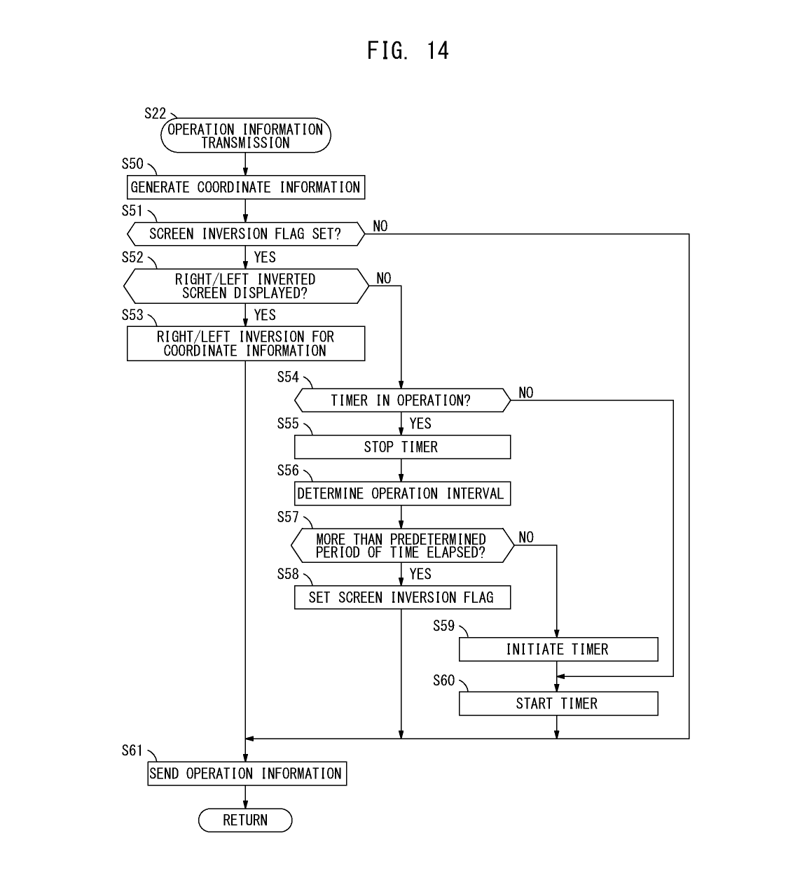

FIG. 14 illustrates a flow diagram explaining an exemplary procedure of the operation information transmission (step S22 of FIG. 10) executed by the information processing device 3 of one or more embodiments in detail. Upon the start of the operation information transmission (step S22), the information processing device 3 generates the coordinate information indicating the position operated by the user (step S50). This process is the same as that in step S40 of FIG. 12. The information processing device 3 determines whether or not the screen inversion flag is set by the display standard determining part 53 (step S51). When the screen inversion flag is not set (when a result of step S51 is NO), the information processing device 3 generates the operation information including the coordinate information generated in step S50 as it is and sends the generated operation information to the image processing device 2 (step S61).

When the screen inversion flag is set (when a result of step S51 is YES), the information processing device 3 determines if the right and left inverted screen created by inverting the screen obtained from the image processing device 2 has already been displayed on the display unit 43 (step S52). The right and left inverted screen created by inverting the screen obtained from the image processing device 2 may have already been displayed on the display unit 43 (when a result of step S52 is YES). In such a case, the information processing device 3 executes the right and left inversion for the coordinate information (step S53). The information processing device 3 then generates the operation information including the coordinate information and sends the generated operation information to the image processing device 2 (step S61).

The screen obtained from the image processing device 2 may be displayed as it is on the display unit 43 (when a result of step S52 is NO), the information processing device 3 determines if a timer mounted on the operation interval counting part 56a is in operation (step S54). If the timer is in operation (when a result of step S54 is YES), the information processing device 3 stops the operation of the timer (step S55), and determines the time interval between the last operation and the current operation which is about to be executed by the operator based on the value counted by the timer at that point of time (step S56). The time interval may be longer than the predetermined period of time (when a result of step S57 is YES). The information processing device 3 then sets the screen inversion flag. The screen inversion flag is set in a predetermined storage region such as the memory of the controller 40 as the screen inversion instruction. The information processing device 3 generates the operation information including the coordinate information generated in step S50 as it is and sends the generated operation information to the image processing device 2 (step S61).

The time interval between the operator's operations may not be longer than the predetermined period of time (when a result of step S57 is NO), the information processing device 3 initiate the value counted by the timer (step S59), and restarts the timer (step S60). The information processing device 3 generates the operation information including the coordinate information generated in step S50 as it is and sends the generated operation information to the image processing device 2 (step S61).

As a result of the determination in step S54, the timer may not be in operation (when a result of step S54 is NO). In such a case, the information processing device 3 starts the timer (step S60). Thus, the operation to count the time until next operation by the operator is started. The information processing device 3 then generates the operation information including the coordinate information generated in step S50 as it is and sends the generated operation information to the image processing device 2 (step S61).

More specifically, after starting the cooperative operation with the image processing device 2, the information processing device 3 of one or more embodiments displays the screen obtained from the image processing device 2 as it is as an initial state. In the initial state, the operation by the operator may be detected. In response to the detection, the information processing device 3 determines the time required from the previous operation to the current operation. If the time longer than the predetermined period of time is collapsed, the information processing device 3 sets the screen inversion flag.

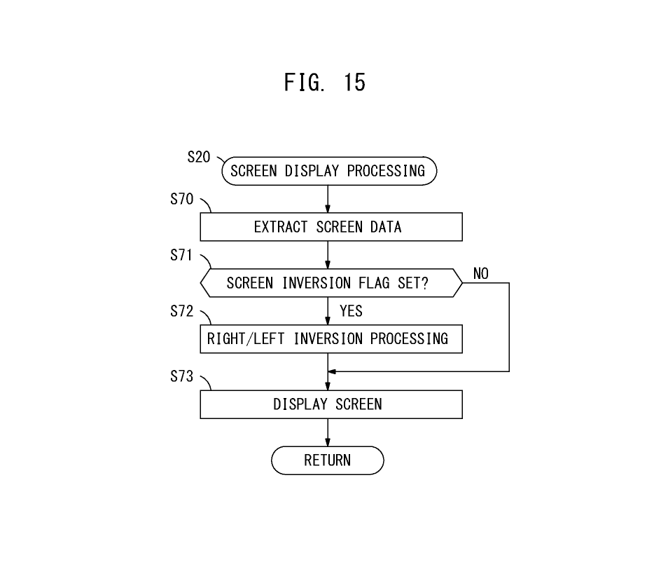

FIG. 15 illustrates a flow diagram explaining an exemplary procedure of the screen display process (step S20 of FIG. 10) executed by the information processing device 3 of one or more embodiments in detail. Upon the start of the screen display process (step S20), the information processing device 3 extracts the screen data 23 from the screen information 21 (step S70). The information processing device 3 determines if the screen inversion flag is set (step S71). The screen inversion flag may be set (when a result of step S71 is YES). In such a case, the information processing device 3 executes the right/left inversion processing with the screen data 23 extracted in step S70 (step S72). The screen inversion flag may not be set (when a result of step S71 is NO). In such a case, the information processing device 3 does not execute the right/left inversion processing. The information processing device 3 then displays the screen on the display unit 43 based on the screen data 23 (step S73). Hence, if the screen inversion flag is set by the operation interval counting part 56a, the right and left inverted screen is displayed on the display unit 43. If the screen inversion by the operation interval counting part 56a is not set, the screen obtained from the image processing device 2 is displayed as it is on the display unit 43.

As described above, the image processing system 1 of one or more embodiments counts the time intervals between the operations by the operator while the screen displayed on the image processing device 2 is displayed on the information processing device 3 as it is so that whether or not the screen makes difficult for the user to operate is determined. When the screen is determined as the screen that makes difficult for the user to operate, the right/left inversion processing is executed for the screen displayed on the information processing device 3. The operator who is acquainted with Arabic or Hebrew is enabled to continue the operation with having the screen displayed on the image processing device 2 displayed as it is. The operator may take long to operate the screen while the screen obtained from the image processing device 2 is displayed as it is on the display unit 43. In such a case, the screen is immediately inverted right and left to be displayed.

Everything else except for the above-described points may be the same as those explained in the above-described embodiments.

Yet additional embodiments of the present invention are explained next. As well as in the above-described embodiments, the information processing device 3 of one or more embodiments displays the screen obtained from the image processing device 2 as it is on the display unit 43. If the operator takes long to execute the operation to the screen, the information processing device 3 inverts the screen right and left. Another example of inverting the screen right and left in such a case different from the above-described embodiments is explained in one or more embodiments. In the above-described embodiments, the time interval between the operator's operations is counted and whether or not the operator takes long to operate the screen is determined based on the counted interval. In one or more embodiments, the number of misoperations executed by the operator is counted, and if the number of the misoperations becomes more than a predetermined number, the screen is inverted right and left.

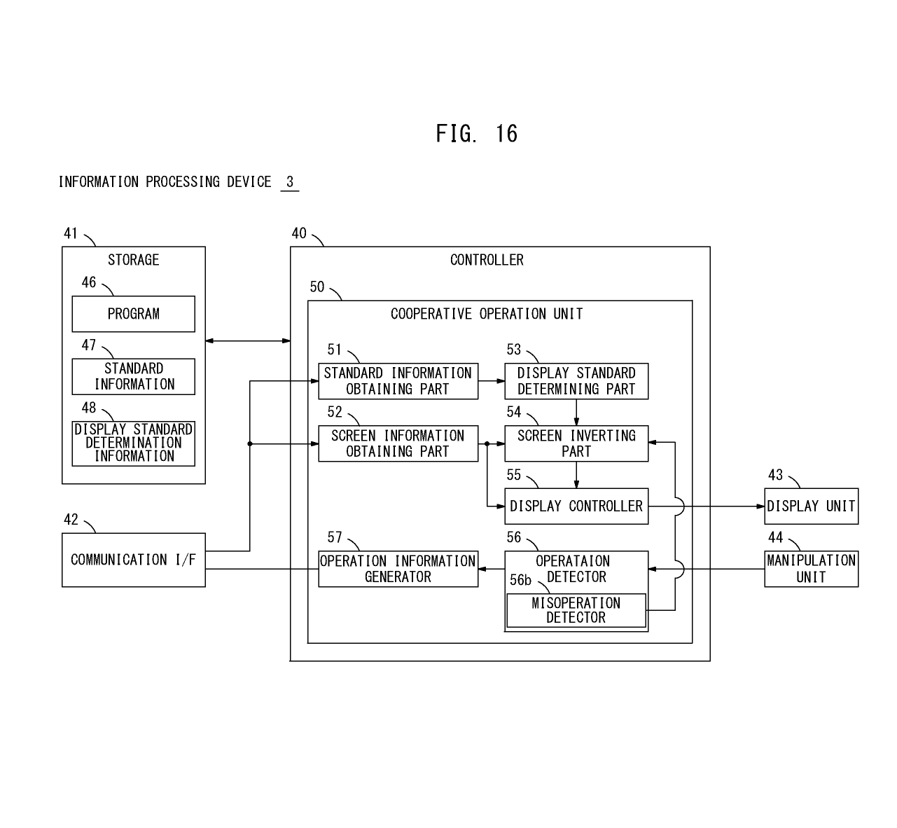

FIG. 16 illustrates a block diagram showing an example of the hardware structure and the functional structure of the information processing device 3 according to one or more embodiments of the present invention. The operation detector 56 is the only difference between the information processing device 3 of one or more embodiments shown in FIG. 16 and the information processing device 3 of the above-described embodiments. The operation detector 56 of one or more embodiments includes a misoperation detector 56b.

Even when the image inversion flag is set in the storage region such as the memory by the display standard determining part 53, the information processing device 3 of one or more embodiments, as well as that of the above-described embodiments, does not immediately enable the screen inverting part 54 to execute the screen inversion processing and displays the screen obtained from the image processing device 2 on the display unit 43 as it is. If the screen inversion instruction is output by the misoperation detector 56b, the information processing device 3 brings the screen inverting part 54 into operation and changes to display the right and left inverted screen on the display unit 43 since then.

The misoperation detector 56b becomes operative when the display standard determining part 53 determines that the screen display standard of the image processing device 2 and the screen display standard of the information processing device 3 are different. The misoperation detector 56b counts the number of the misoperations if the operator executes the misoperation while the screen obtained from the image processing device 2 is displayed on the display unit 43 as it is. In response to detecting that the counted number of the misoperations by the operator becomes more than the predetermined number, the misoperation detector 56b outputs the screen inversion instruction.

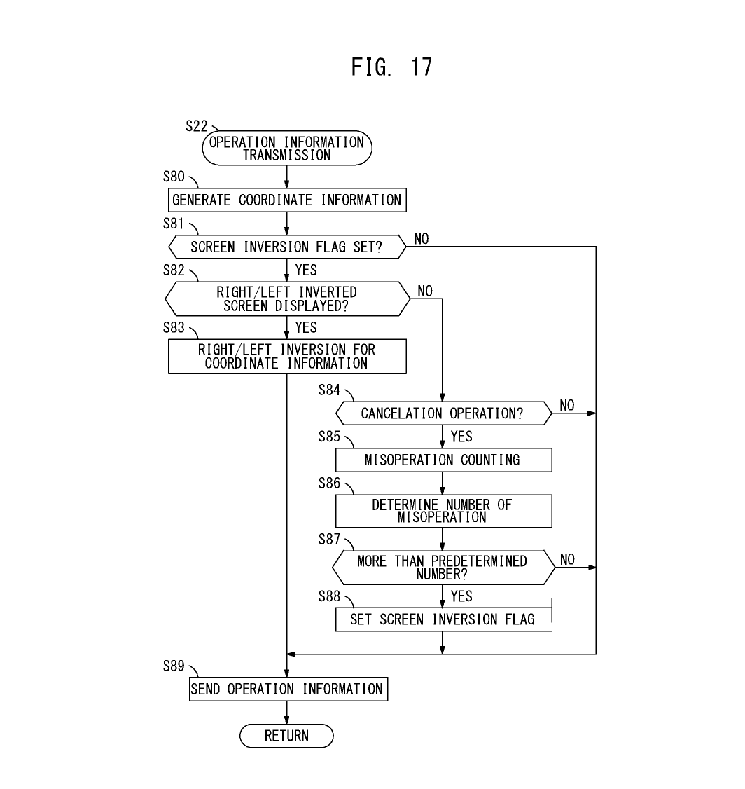

FIG. 17 illustrates a flow diagram explaining an exemplary procedure of the operation information transmission (step S22 of FIG. 10) executed by the information processing device 3 of one or more embodiments in detail. Upon the start of the operation information transmission (step S22), the information processing device 3 generates the coordinate information indicating the position operated by the user (step S80). This process is the same as that in step S40 of FIG. 12. The information processing device 3 determines whether or not the screen inversion flag is set by the display standard determining part 53 (step S81). When the screen inversion flag is not set (when a result of step S81 is NO), the information processing device 3 generates the operation information including the coordinate information generated in step S80 as it is and sends the generated operation information to the image processing device 2 (step S89).

When the screen inversion flag is set (when a result of step S81 is YES), the information processing device 3 determines if the right and left inverted screen created by inverting the screen obtained from the image processing device 2 has already been displayed on the display unit 43 (step S82). The right and left inverted screen created by inverting the screen obtained from the image processing device 2 may have already been displayed on the display unit 43 (when a result of step S82 is YES). In such a case, the information processing device 3 executes the right/left inversion processing for the coordinate information (step S83). The information processing device 3 then generates the operation information including the coordinate information and sends the generated operation information to the image processing device 2 (step S89).

The screen obtained from the image processing device 2 may be displayed as it is on the display unit 43 (when a result of step S82 is NO), the information processing device 3 brings the misoperation detector 56b into operation to determine if the cancelation operation is executed by the operator (step S84). In one or more embodiments, if the cancelation operation is executed by the operator, the operation executed just before the cancelation operation is detected as the misoperation. However, this is given not for limitation. The misoperation may be detected in a different manner. When the cancelation operation is executed by the operator (when a result of step S84 is YES), the information processing device 3 executes a misoperation counting (step S85), and determines the number of the misoperations after counting the current misoperation (step S86). The number of the misoperations may be more than the predetermined number (when a result of step S87 is YES). In such a case, the information processing device 3 sets the screen inversion flag (step S88). The screen inversion flag is set in the predetermined storage region such as the memory of the controller 40 as the instruction on the screen inversion processing. The information processing device 3 generates the operation information including the coordinate information generated in step S80 as it is and sends the generated operation information to the image processing device 2 (step S89).

When the misoperation is not executed by the operator (when a result of step S84 is NO) or the number of the misoperations is not more than the predetermined number (when a result of step S87 is NO), the information processing device 3 generates the operation information including the coordinate information generated in step S80 as it is and sends the generated operation information to the image processing device 2 (step S89).

to be more specific, the information processing device 3 of one or more embodiments displays the screen obtained from the image processing device 2 as it is as the initial state upon the start of the cooperative operation with the image processing device 2. In response to detecting the misoperation by the operator in the initial state, the information processing device 3 counts the number of the misoperations. If the number of the misoperations reaches more than the predetermined number, the information processing device 3 sets the screen inversion flag.

The screen display process (step S20 of FIG. 10) executed by the information processing device 3 of one or more embodiments is the same as that explained in the above-described embodiments.

As described above, the image processing system 1 of one or more embodiments counts the number of the misoperations executed by the operator while the screen displayed on the image processing device 2 is displayed on the information processing device 3 as it is so that whether or not the screen makes difficult for the user to operate is determined. When the screen is determined as the screen that makes difficult for the user to operate, the right/left inversion processing is executed for the screen displayed on the information processing device 3. The same working effect as the above-described embodiments may be obtained.

Everything else except for the above-described points may be the same as those explained in the above-described embodiments.

Yet additional embodiments of the present invention are explained next. The screens displayed on the display unit 13 of the image processing device 2 include a variety of screens. When an error such as a paper jam is occurred at the image processing device 2, for instance, the screen to request the operation to resolve the error is displayed on the display unit 13. The screen to request the user for the operation to resolve the error such as the paper jam may include the image of the image processing device 2. More specifically, in order to resolve the error such as the paper jam, the image of the image processing device 2 is used to show a part such as a door that should be opened by the user.

The image of the image processing device 2 may also be inverted when the screen is inverted right and left. The operator looking at the screen then may not accurately give a guidance to the user on the door to open, for instance. In one or more embodiments, an example where a part of the image included in the screen is not inverted when the screen inverting part 54 inverts the screen to display on the display unit 43 is explained.

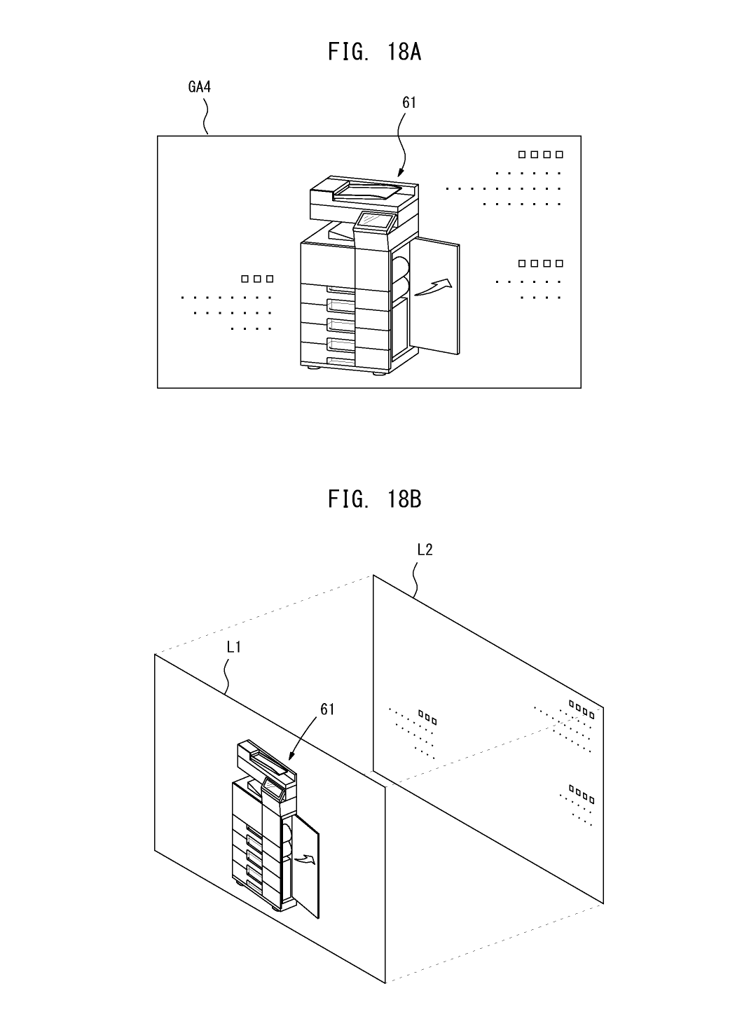

FIGS. 18A and 18B each illustrate an example of the screen including an image 61 of the image processing device 2 according to one or more embodiments of the present invention. FIG. 18A illustrates a screen GA4 displayed on the display unit 13 of the image processing device 2. The screen GA4 includes the image 61 of the whole image processing device 2 in a part of an area of the screen GA4. FIG. 18B illustrates an example of data structure of the screen GA4. As illustrated in FIG. 18B, the screen GA4 includes a layer image L1 and a layer image L2 superimposed on top of another. The layer image L1 includes the image 61 of the image processing device 2, and the layer image L2 includes the other screen elements except for the image 61 of the image processing device 2.

The screen obtained from the image processing device 2 may be the screen including the image 61 of the image processing device 2 in a part as illustrated in FIGS. 18A and 18B. In such a case, the screen inverting part 54 executes the right/left inversion processing only for the layer image L2 and does not execute the right/left inversion processing for the layer image L1. As a result, the image 61 of the image processing device 2 is not inverted right and left and only the other screen elements (such as icon image) are inverted right and left and displayed on the display unit 43.

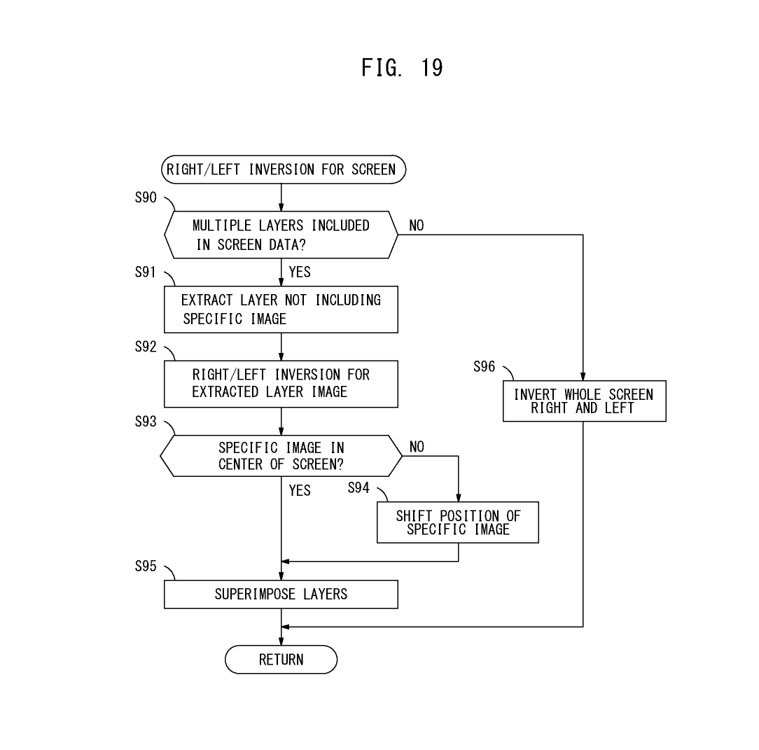

FIG. 19 illustrates a flow diagram explaining an exemplary procedure of the right/left inversion processing for the screen executed by the information processing device 3 according to one or more embodiments of the present invention. This process is executed as the process in step S32 of FIG. 11 or step S72 of FIG. 15, for example. Upon the start of the process, the information processing device 3 determines if the screen data 23 obtained from the image processing device 2 includes multiple layer images (step S90). The screen data 23 may include multiple layer images (when a result of step S90 is YES). In this case, the information processing device 3 extracts the layer image L2 which does not include a specific image (the image 61 of the image processing device 2) from the multiple layer images (step S91). The information processing device 3 then executes the right/left inversion processing for the extracted layer image L2 (step S92).

After executing the right/left inversion processing for the layer image L2, the information processing device 3 determines whether or not the specific image is arranged in the center of the screen of the layer image L1 which includes the specific image (step S93). More specifically, whether or not the specific image is arranged in the center of the screen of the layer image L1 in the screen horizontal direction (right and left direction) is determined. When the specific image is arranged in the center of the screen of the layer image L1 (when a result of step S93 is YES), the information processing device 3 does not execute any process with the layer image L1. When the specific image is not arranged in the center of the screen of the layer image L1 (when a result of step S93 is NO), the information processing device 3 shifts the position of the specific image included in the layer image L1 in the horizontal direction (step S94). As a result, this may prevent the position of the specific image from being off when the specific image and the right and left inverted layer image L2 are being superimposed on top of another. The information processing device 3 then superimposes the layer image L1 including the specific image and the right and left inverted layer image L2 on top of another to generate the screen data to be displayed on the display unit 43 (step S95).

The screen data 23 obtained from the image processing device 2 may not include multiple layer images (when a result of step S90 is NO). In this case, the information processing device 3 inverts the whole screen data 23 right and left (step S96).

Through the above-described process, when the screen data 23 obtained from the image processing device 2 includes the image 61 of the image processing device 2, the screen which shows the right and left inverted the other screen elements and the image 61 of the image processing device 2 not being inverted right and left may be displayed on the display unit 43. In the example of FIGS. 18A and 18B, the image 61 showing the whole body of the image processing device 2 is included in the screen. However, this is given not for limitation. The image may be the one only showing a part of the image processing device 2.

Everything else except for the above-described points are the same as those explained in the above-described embodiments.

Yet additional embodiments of the present invention are explained next. In the embodiments described above, the example where the screen information 21 is sent from the image processing device 2 to the information processing device 3, and the screen data 23 is included in the screen information 21 is explained. The screen data 23, however, has a relatively big amount of data. If a path having a low communication speed is included in the communication paths between the image processing device 2 and the information processing device 3, the information processing device 3 is not enabled to display the screen effectively. In one or more embodiments, only the screen ID 22 is sent to the information processing device 3 from the image processing device 2, and the information processing device 3 displays the screen corresponding to the screen ID 22 received from the image processing device 2 on its display unit.

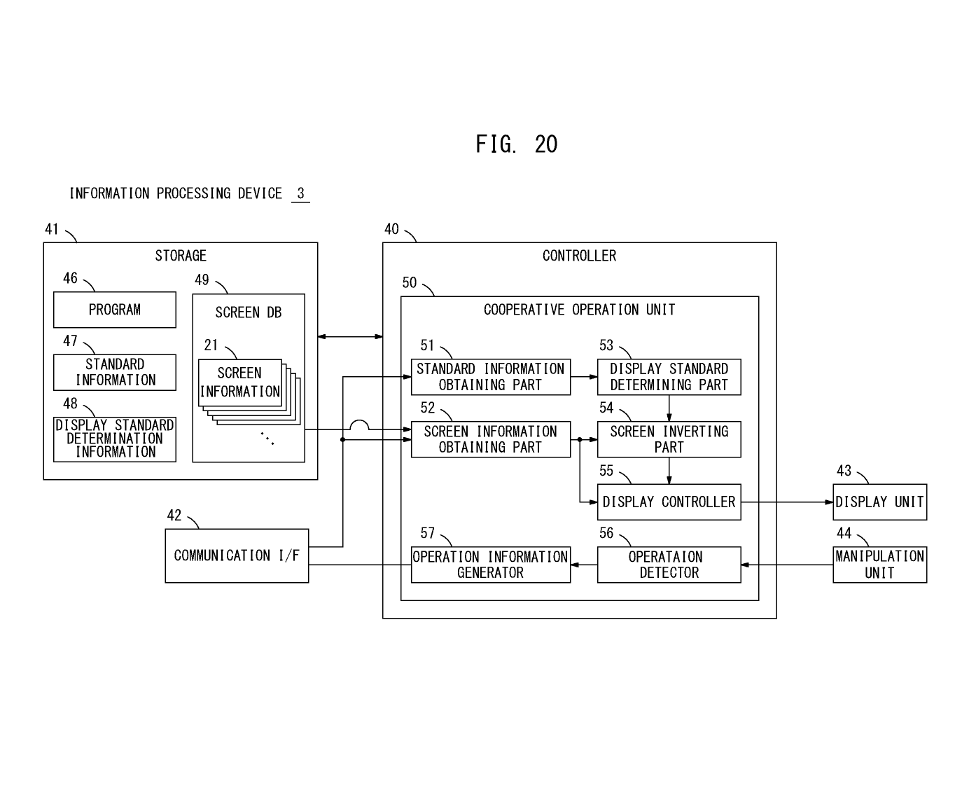

FIG. 20 illustrates a block diagram showing an example of the hardware structure and the functional structure of the information processing device 3 according to one or more embodiments of the present invention. A screen database (hereafter, screen DB) 49 included in the storage 41 is the only difference between the information processing device 3 of one or more embodiments shown in FIG. 20 and the information processing device 3 of the above-described embodiments. The screen information 21 stored in the storage 11 of the image processing device 2 placed in each country is stored in the screen DB 49. Every screen data 23 displayed on the display unit 13 of the image processing device 2 placed in each country is stored in the screen DB 49.

When the screen information obtaining part 52 of the information processing device 3 of one or more embodiments receives the screen ID 22 from the image processing device 2, it retrieves the screen DB 49 based on the screen ID 22 so that the screen data 23 corresponding to the screen displayed on the display unit 13 of the image processing device 2 may be obtained from the screen DB 49.

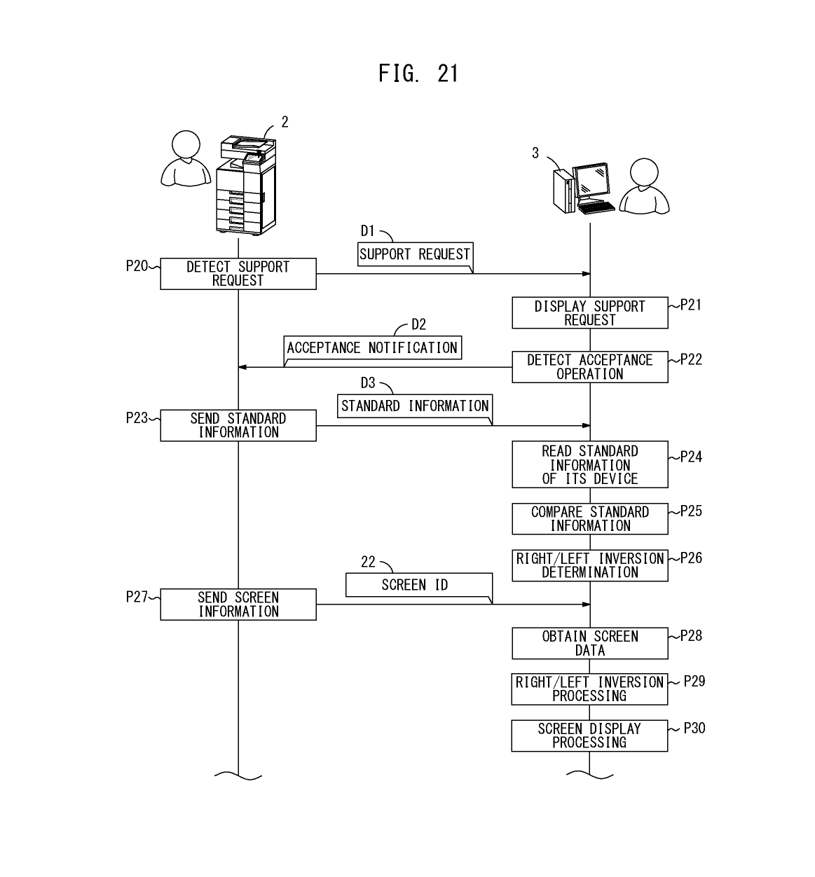

FIG. 21 is a flow diagram showing an exemplary operation executed by the image processing device 2 and the information processing device 3 according to one or more embodiments of the present invention. The operations in process P20 to P26 of FIG. 21 executed after the image processing device 2 detects the support request operation by the user and until the information processing device 3 executes the right/left inversion processing are the same as the operations in process P1 to P7 of FIG. 2. In the example of FIG. 21, it is determined that the right and left inversion processing needs to be executed as a result of the right/left inversion determination in the process P26.

The image processing device 2 extracts the screen ID 22 from the screen information 21 corresponding to the screen displayed on the display unit 13, and sends the extracted screen ID 22 to the information processing device 3 (process P27). The screen data 23 such as the bitmap image or the web page is not sent to the information processing device 3 in this process. The screen ID 22 has a small data amount such as few bites. Even when the path having the low communication speed is included in the communication paths between the image processing device 2 and the information processing device 3, the transmission and receipt may be effectively conducted.

In response to receiving the screen ID 22 from the image processing device 2, the information processing device 3 retrieves the screen DB 49 and obtains the screen data 23 corresponding to the screen ID 22 (process P28). The information processing device 3 executes the right/left inversion processing for the screen data 23 obtained from the screen DB 49 (process P29), and displays the right and left inverted screen on the display unit 43 (process P30).

As described above, in one or more embodiments, only the screen ID 22 is sent to the information processing device 3 from the image processing device 2. The screen ID 22 has a small data amount such as few bites. Even when the path having the low communication speed is included in the communication paths between the image processing device 2 and the information processing device 3, the transmission and receipt may be effectively conducted.

Everything else except for the above-described points are the same as those explained in the embodiments as described earlier.

Yet additional embodiments of the present invention are explained next. In one or more embodiments, when the information processing device 3 inverts the screen displayed on the image processing device 2 right and left and displays the right and left inverted screen on the display unit 43, both of the right and left inverted screen and the screen not inverted right and left are displayed on the display unit 43.

After the information processing device 3 brings the screen inverting part 54 to create the right and left inverted screen based on the screen obtained from the image processing device 2, it outputs the original screen not inverted right and left together with the right and left inverted screen to the display controller 55. The display controller 55 arranges the right and left inverted screen and the original screen not inverted right and left in vertical direction or lateral direction and displays them on the display unit 43.

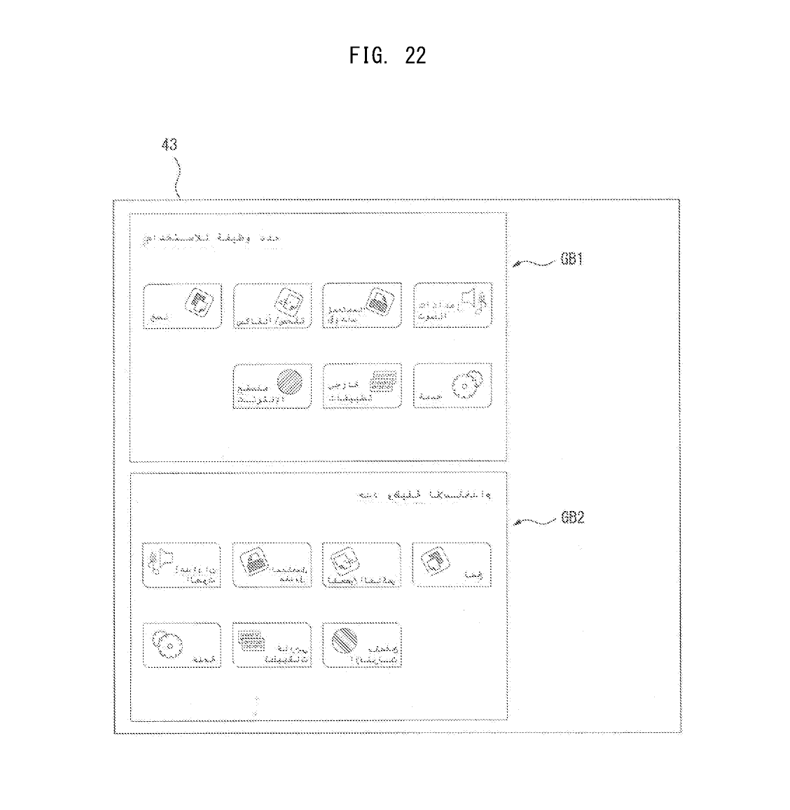

FIG. 22 illustrates an example of displaying two screens GB1 and GB2 on the display unit 43 according to one or more embodiments of the present invention. The screen GB1 as illustrated in FIG. 22 is the screen created by inverting the screen obtained from the image processing device 2. The screen GB2 is the screen obtained from the image processing device 2 and being displayed as it is. In the example of FIG. 22, the two screens GB1 and GB2 are arranged in vertical direction. However, this is given not for limitation. The two screens GB1 and GB2 may be arranged in lateral direction.

A cursor such as a mouse pointer indicating the position being operated by the operator may be displayed while the right and left inverted screen GB1 and the screen not inverted right and left GB2 are displayed on the display unit 43. In such a case, the display controller 55 inverts the display position of the cursor right and left and displays the right and left inverted screen with the right and left inverted cursor and the screen not inverted right and left with the cursor not inverted right and left. As a result, the cursors indicating the position operated by the operator may be displayed on the same icons on the respective two screens GB1 and GB2.

As described above, if the two screens GB1 and GB2 are displayed on the display unit 43, the operator may give a guidance looking at the screen which is easier for him or her to understand. Even when, for example, the operator gives a guidance to the user looking at the right and left inverted screen GB1, he or she may proceed with the explanation confirming the status of the screen not inverted right and left which is actually being looked by the user. To be more specific, the operator looking at the right and left inverted screen GB1 may explain to the user to operate the icon image which is second from the left. In this case, the operator confirms the screen not inverted right and left GB2 so that he or she may easily find out that icon image is second from right as the user faces the image. This enables the operator to give a smooth and accurate guidance on the correct operation.

Everything else except for the above-described points are the same as those explained in the embodiments as described earlier.

Yet additional embodiments of the present invention are explained next. In the above-described embodiments, the information processing device 3 executes the right/left inversion processing for the screens. In one or more embodiments, the image processing device 2 executes the right/left inversion processing for the screens.

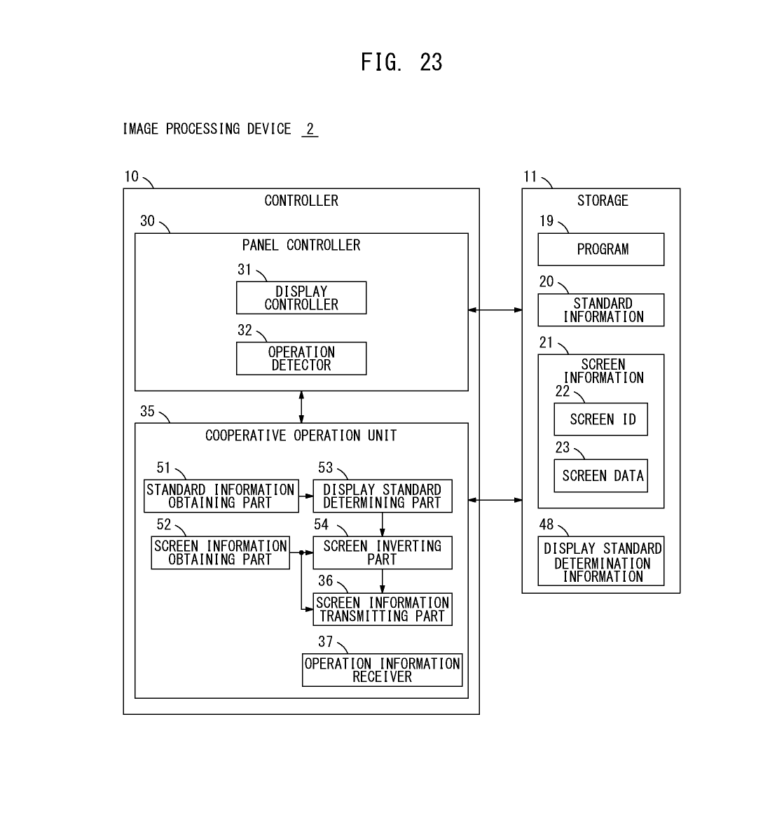

FIG. 23 illustrates a block diagram showing an example of the functional structure of the image processing device 2 according to one or more embodiments of the present invention. The CPU executes the program 19 so that the controller 10 of the image processing device 2 brings the cooperative operation unit 35 that operates in cooperation with the information processing device 3 into operation. The cooperative operation unit 35 of one or more embodiments includes the standard information obtaining part 51, the screen information obtaining part 52, the display standard determining part 53 and the screen inverting part 54 besides the screen information transmitting part 36 and the operation information receiver 37. Each of the standard information obtaining part 51, the screen information obtaining part 52, the display standard determining part 53 and the screen inverting part 54 is the same as that included in the information processing device 3 of the above-described embodiments.

When the communication interface 42 receives information from the information processing device 3, the standard information obtaining part 51 determines if the received information is the standard information 47 of the information processing device 3. If the received information is the standard information 47, the standard information obtaining part 51 obtains the standard information 47. The standard information obtaining part 51 outputs the standard information 47 obtained from the information processing device 3 to the display standard determining part 53.

The screen information obtaining part 52 obtains the screen information 21 of the screen displayed on the display unit 13 by the display controller 31 of the panel controller 30. The screen information obtaining part 52 may obtain the screen information 21 from the display controller 31, or may read and obtain the screen information 21 in the storage 11. The screen information obtaining part 52 extracts the screen data 23 from the obtained screen information 21, and outputs the screen data 23 to the screen inverting part 54 or the screen information transmitting part 36.

After obtaining the standard information 47 of the information processing device 3, the display standard determining part 53 determines whether the screen display standard of the display unit 43 of the information processing device 3 is the left standard or the right standard. The display standard determining part 53 may refer to the display standard determination information 48 stored in the storage 11. The display standard determining part 53 reads the standard information 20 regarding its device in the storage 11, and determines whether the screen display standard of the display unit 13 of its device is the left standard or the right standard. The display standard determining part 53 compares the screen display standard of the display unit 13 and the screen display standard of the display unit 43 with each other, thereby determining whether or not both standards are the same.

The screen display standard of the display unit 13 and the screen display standard of the display unit 43 may be the same. In such a case, the image processing device 2 finds out that the right/left inversion processing for the screen to send to the information processing device 3 is unnecessary. On the other hand, the screen display standard of the display unit 13 and the screen display standard of the display unit 43 may be differ from each other. In such a case, the image processing device 2 finds out that the right/left inversion processing for the screen to send to the information processing device 3 is necessary. The display standard determining part 53 temporarily stores the result of the determination which is conducted by comparing the screen display standard of the display unit 13 and the screen display standard of the display unit 43 with each other in the memory of the controller 10, for instance. The determination result stored in the memory, for instance, is deleted at the timing when the cooperative operation between the image processing device 2 and the information processing device 3 is complete, for instance.

In response to obtaining the screen information 21 of the screen displayed on the image processing device 2, the screen information obtaining part 52 refers to the determination result conducted by the display standard determining part 53 stored in the memory. When the right/left inversion processing for the screen to send to the information processing device 3 is not necessary, the screen information obtaining part 52 outputs the screen information 21 to the screen information transmitting part 36. On the other hand, if the right/left inversion processing for the screen to send to the information processing device 3 is necessary, the screen information obtaining part 52 outputs the screen information 21 to the screen inverting part 54.

The screen inverting part 54 executes the processing to invert the screen to send to the information processing device 3 right and left when it is determined the screen display standard of the display unit 13 and the screen display standard of the display unit 43 are different from each other. To be more specific, the screen inverting part 54 extracts the screen data 23 from the screen information 21 received from the screen information obtaining part 52, and executes the right/left inversion processing for the screen data 23. Thus, the screen sent to the information processing device 3 is converted into the right and left inverted screen. The screen inverting part 54 outputs the screen information 21 including the right and left inverted screen data 23 to the screen information transmitting part 36.

The screen information transmitting part 36 sends the screen information 21 received from the screen information obtaining part 52 or the screen inverting part 54 to the information processing device 3 so that the screen operable for the operator may be provided to the information processing device 3. Thus, the information processing device 3 is enabled to obtain the same screen as the screen displayed on the image processing device 2 and display it on the display unit 43.

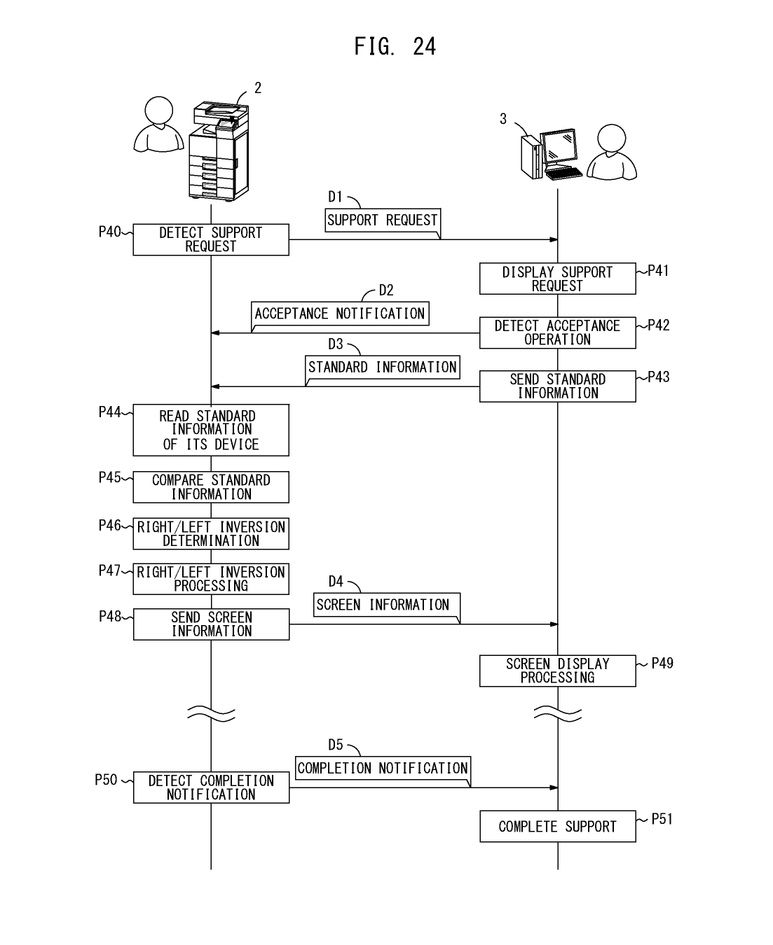

FIG. 24 is a flow diagram showing an exemplary operation executed by the image processing device 2 and the information processing device 3 according to one or more embodiments of the present invention. The process in processes P40 to P42 of FIG. 24 until receiving the acceptance notification D2 from the information processing device 3 from the image processing device 2 detecting the support request operation executed by the user is the same process as the process in the processes P1 to P3 of FIG. 2. Also, in the example of FIG. 24, it is determined that the right/left inversion processing for the screen is necessary as a result of the right/left inversion determination in process P46.

The connection between the image processing device 2 and the information processing device 3 is established and the interactive communication between the image processing device 2 and the information processing device 3 may be enabled. The information processing device 3 then reads the standard information 47 regarding its device stored in the storage 41 and sends the read standard information 47 to the image processing device 2 (step S43). When receiving the standard information 47 from the information processing device 3, the image processing device 2 reads the standard information 20 regarding its device in the storage 11 (process P44). The image processing device 2 compares the standard information 47 received from the information processing device 3 and the standard information 20 regarding its device with each other (process P45), and executes the right/left inversion determination (process P46). More specifically, the information processing device 3 determines if the right/left inversion processing is necessary. More specifically, the image processing device 2 determines if the right/left inversion processing should be executed for the screen to send to the information processing device 3. The image processing device 2 stores the result of the right/left inversion determination in the memory, for instance. In a below explanation as to FIG. 24, a case where the information processing device 3 determines the right/left inversion processing should be executed for the screen as the result of the right/left inversion determination is explained.

The image processing device 2 then extracts the screen data 23 from the screen information 21 corresponding to the screen currently being displayed on the display unit 13 of the operational panel 12, and executes the right/left inversion processing for the screen data 23 (process P47). The image processing device 2 executes the right/left inversion processing for the screen, and generates screen information D7 including the right and left inverted screen data 23. The image processing device 2 sends the screen information D7 to the information processing device 3 (process P48). In response to receiving the screen information D7 from the image processing device 2, the information processing device 3 extracts the right and left inverted screen data 23 in the screen information D7, and displays the screen based on the extracted screen data 23 on the display unit 43 (process P49). The same process is also executed when the screen is updated by the image processing device 2 after process in process P49.

In response to detecting the completion request operation by the user, the image processing device 2 cancels the connection between the image processing device 2 and the information processing device 3 (processes P50 to P51).

During the above-described process executed by the image processing device 2 and the information processing device 3, the operator may operate the screen displayed on the display unit 43 for the user so that the operator may give the correct guidance to the user. In such a case, the information processing device 3 generates the coordinate information that indicates the position operated by the operator in the screen displayed on the display unit 43, and sends the operation information including the coordinate information to the image processing device 2. The information processing device 3 sends the coordinate information to the image processing device 2 as it is despite the screen displayed on the display unit 43 is created by inverting the screen displayed on the image processing device 2 right and left. More specifically, in one or more embodiments, the information processing device 3 is not enabled to determine whether or not the screen displayed on the display unit 43 is the right and left inverted screen so that the information processing device 3 sends the coordinate information to the image processing device 2 as it is.

In response to receiving the operation information including the coordinate information from the information processing device 3, the image processing device 2 determines if the screen sent to the information processing device 3 is the right and left inverted screen. The screen sent to the information processing device 3 may be the right and left inverted screen. In such a case, the image processing device 2 executes the right/left inversion processing for the coordinate information received from the information processing device 3. As a result, the coordinate included in the coordinate information may be the coordinate corresponding to the screen displayed on the display unit 13 of the operational panel 12. The image processing device 2 identifies the operation executed by the operator based on the right and left inverted coordinate information, and executes the process based on the operation. The screen sent to the information processing device 3 may not be the right and left inverted screen. In such a case, the image processing device 2 does not execute the right/left inversion processing for the coordinate information received from the information processing device 3.

As described above, even the image processing device 2 has the structure that executes the right/left inversion processing for the screen, the same working effect as that explained in the above-described embodiments may be obtained.

Everything else except for the above-described points are the same as those explained in the embodiments as described earlier.

Although the embodiments of the present invention have been described and illustrated in detail, it is clearly understood that the same is by way of illustration and example only and not limitation, the scope of the present invention should be interpreted by terms of the appended claims.

### Modifications

While the embodiments of the present invention have been described above, the present invention is not limited to these embodiments. Various modifications may be applied to the present invention.

In the above-described embodiments, for example, each of the standard information 20 and 27 includes information relating to the language and information relating to the screen display standard. Based on the information, whether the screen display standard is left standard or right standard is determined. The information to determine the screen display standard does not have to be the information relating to the language and/or the information relating to the screen display standard. If, for example, country information of the country where the image processing device 2 is placed is included in the standard information 20 and/or 27, the directionality of written official language may be determined based on the country information. The information such as the country information may be one type of the standard information 20 and/or 27.

In the above-described embodiments, the image processing device 2 is constructed by a device such as the MFP including multiple functions such as the scan function, the print function, the copy function and the fax function. The image processing device 2 does not have to include the multiple functions. The image processing device 2 may be a scanner only including the scan function or a printer only including the print function. The image processing device 2 may be a device including a function except for the scan function, the print function, the copy function and the fax function. To be more specific, the image processing device 2 may be any device if it is capable of displaying the screen operable for the user.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image processing system comprises:
an image processing device that comprises:
a first display; and
a first hardware processor; and
an information processing device that communicates with the image processing device, and comprises:
a second display on which a second screen same as a first screen being displayed on the first display is displayed; and
a second hardware processor, wherein
one of the first hardware processor and the second hardware processor:
determines whether a screen display standard of the first display is left standard or right standard, and determines whether a screen display standard of the second display is left standard or right standard, and
inverts the second screen that is same as the first screen being displayed on the first display and is displayed on the second display right and left, when the screen display standard of the first display and the screen display standard of the second display are determined to be different from each other.

2. The image processing system according to claim 1, wherein
the first hardware processor sends screen information of the first screen displayed on the first display and standard information indicating the screen display standard of the first display to the information processing device,
the second hardware processor determines whether the screen display standard of the first display is left standard or right standard based on the standard information received from the image processing device, and
inverts the second screen that is same as the first screen being displayed on the first display and is displayed on the second display right and left, based on the screen information received from the image processing device, when the screen display standard of the first display and the screen display standard of the second display are determined to be different from each other.

3. The image processing system according to claim 2, wherein
the screen information includes a bitmap image to be displayed on the second display, and
the second hardware processor inverts the bitmap image right and left.

4. The image processing system according to claim 2, wherein
the screen information includes a web page to be displayed on the second display, and
the second hardware processor inverts the web page right and left.

5. The image processing system according to claim 2, wherein
the information processing device further comprises a storage that stores screen data of a plurality of types of first and second screens displayed on the first and second display,
the screen information includes screen identification information to specify the first screen being displayed on the first display, and
the second hardware processor reads the screen data of the second screen same as the first screen being displayed on the first display from the storage based on the screen identification information, and inverts the screen data right and left.

6. The image processing system according to claim 2, wherein
the standard information includes information relating to directionality of written letters included in the first screen, and
the second hardware processor determines that the screen display standard of the first display and the screen display standard of the second display are different from each other, when the directionality of written letters included in the first screen displayed on the first display is different from the directionality of written letters included in the second screen displayed on the second display.

7. The image processing system according to claim 1, wherein
the second hardware processor counts a time interval of operations by an operator while the second screen same as the first screen being displayed on the first display is being displayed on the second display, and
the one of the hardware processors inverts the second screen being displayed on the second display right and left, when the screen display standard of the first display and the screen display standard of the second display are determined to be different from each other and when the counted time interval of operations by the operator is longer than a predetermined period of time.

8. The image processing system according to claim 1, wherein
the second hardware processor detects a misoperation by the operator while the second screen same as the first screen being displayed on the first display is being displayed on the second display, and
the one of the hardware processors inverts the second screen being displayed on the second display right and left, when the screen display standard of the first display and the screen display standard of the second display are determined to be different from each other and when the number of the misoperation by the operator detected in a predetermined period of time is more than a predetermined number.

9. The image processing system according to claim 1, wherein
the second hardware processor generates coordinate information indicating a position operated by the operator on the second screen and sends operation information including the coordinate information to the image processing device when the operation by the operator to the second screen being displayed on the second display is detected, and
generates the right and left inverted coordinate information indicating the position operated by the operator when the right and left inverted second screen is being displayed on the second display.

10. The image processing system according to claim 1, wherein
the second hardware processor sends standard information indicating the screen display standard of the second display,
the first hardware processor determines whether the screen display standard of the second display is left standard or right standard based on the standard information received from the information processing device, and
inverts the second screen that is same as the first screen being displayed on the first display and is displayed on the second display right and left, and sends the right and left inverted second screen to the information processing device when the screen display standard of the first display and the screen display standard of the second display are determined to be different from each other.

11. The image processing system according to claim 1, wherein
the one of the hardware processors does not invert a part of an image included in the second screen when the second screen to be displayed on the second display is inverted right and left.

12. The image processing system according to claim 11, wherein
the part of the image shows a whole body or a part of the image processing device.

13. The image processing system according to claim 1, wherein
the one of the hardware processors displays the image not inverted right and left together with the right and left inverted image when the second screen same as the first screen being displayed on the first display is displayed on the second display.

14. The image processing system according to claim 13, wherein
the one of the hardware processors inverts a display position of a cursor that shows the position being operated by the operator right and left, and
displays the right and left inverted second screen with the right and left inverted cursor, and the second screen not inverted right and left with the cursor not inverted right and left, on the second display.

15. An information processing device that communicates with an image processing device comprising a first display, and comprises a second display that displays a second screen same as a first screen being displayed on the first display, the information processing device comprising a hardware processor that:
determines whether a screen display standard of the first display is left standard or right standard, and determines whether a screen display standard of the second display is left standard or right standard; and
inverts the second screen that is same as the first screen being displayed on the first display and is displayed on the second display right and left, when the screen display standard of the first display and the screen display standard of the second display are determined to be different from each other.

16. An image processing device, comprising:
a first display that displays a first screen operable by a user; and
a hardware processor that:
communicates with an information processing device that comprises a second display displaying a second screen same as the first screen being displayed on the first display;
determines whether a screen display standard of the first display is left standard or right standard, and determines whether a screen display standard of the second display is left standard or right standard; and
inverts the second screen that is same as the first screen being displayed on the first display and is displayed on the second display right and left, when the screen display standard of the first display and the screen display standard of the second display are determined to be different from each other.

17. A non-transitory recording medium storing a computer readable program executed by a hardware processor of an information processing device that communicates with an image processing device comprising a first display, and comprises a second display that displays a second screen same as a first screen being displayed on the first display, the computer readable program causing the hardware processor of the information processing device to execute:
determining whether a screen display standard of the first display is left standard or right standard, and determines whether a screen display standard of the second display is left standard or right standard; and
inverting the second screen that is same as the first screen being displayed on the first display and is displayed on the second display right and left, when the screen display standard of the first display and the screen display standard of the second display are determined to be different from each other.

18. A non-transitory recording medium storing a computer readable program executed by a hardware processor of an image processing device that comprises a first display and displays a first screen operable by a user on the first display, the program causing the hardware processor of the image processing device to execute:
communicating with an information processing device that comprises a second display displaying a second screen same as the first screen being displayed on the first display;
determining whether a screen display standard of the first display is left standard or right standard, and determines whether a screen display standard of the second display is left standard or right standard; and
inverting the second screen that is same as the first screen being displayed on the first display and is displayed on the second display right and left, when the screen display standard of the first display and the screen display standard of the second display are determined to be different from each other.
